(19) United States
(12) Patent Application Publication
(10) Pub. No.: US 2023/0167144 A1
(43) Pub. Date: Jun. 1, 2023

(54) PREPARATION AND ITS APPLICATION OF A CYANIDE-BRIDGED METAL ORGANIC COMPOUND WITH INTRAMOLECULAR MAGNETIC TRANSFORMATION

(71) Applicants: Jingchu University of Technology, Jingmen City (CN); Hubei Jingmen Industrial Technology Research Institute Co., Ltd., Jingmen City (CN)

(72) Inventors: Yong Wang, Jingmen City (CN); Jianmei Hu, Jingmen City (CN)

(21) Appl. No.: 17/536,588

(22) Filed: Nov. 29, 2021

(51) Int. Cl. C07F 15/00; H01F 1/42

(52) U.S. Cl. CPC C07F 15/0046; H01F 1/42

(57) ABSTRACT

This invention describes the preparation and its application of a cyanide bridged metal organic compound with intramolecular magnetic transition. The general structural formula of the compound is [(L2)(L1)M1(NC)M2(L3)ₘ(CN)M1(L1)(L2)](PF₆)₆, n=2, 3, or 4. Damagnetic cyanidometal-bridge polynuclear compound [(L2)(L1)M1(NC)M(L)m(CN)M1(L1)(L2)](PF₆)₂ is synthesized by compound M(L1)(L2)X (X=Cl, Br or I) with redox activity is selected as the terminal group fragment, and M(L)₂(CN)₂ is selected as the central bridging ligand, using solution. Carry out electrochemical research on compound [(L2)(L1)M1(NC)M(L)m(CN)M1(L1)(L2)](PF₆)₂, select the appropriate oxidant, and obtain the one-electron oxidation product [(L2)(L1)M1(NC) M(L)ₘ(CN)M1(L1)(L2)](PF₆)₃ and two-electron oxidation product [(L2)(L1)M1(NC)M(L)ₘ(CN)M1(L1)(L2)](PF₆)₄. The cyanide-bridged metal organic compound is a cyanide bridged polynuclear compound that bridges by two diamagnetic metal fragments through a cyano group on a paramagnetic ion. According to its electrochemical and magnetic properties, it can be used for molecular-based magnetic materials. The preparation method is simple and the process conditions are easy to control.

### FIELD OF THE DISCLOSURE

The invention belongs to the field of magnetic functional materials, and specifically relates to the preparation and its application of a cyanide-bridged metal organic compound with intramolecular magnetic transformation.

### BACKGROUND OF THE DISCLOSURE

The birth and development of information technology is one of the greatest creations of mankind in the 20th century. The information storage technology of magnetic materials has achieved the brilliance of the microelectronics industry, enabling mankind to move from an industrial society to an information society. Magnetic materials are the foundation of information storage and directly affect and master the development level of the information technology industry. With the miniaturization of storage devices, the continuous improvement of storage capacity requirements, and the application requirements of newly developed molecular electronics, it is difficult to meet the needs of traditional magnetic materials with high density, difficult precision processing and molding, and large magnetic loss. As a kind of potential materials that can meet the application requirements of molecular electronics, molecular-based magnetic materials have been widely studied by scientists in various fields. Compared with traditional magnetic materials, molecular magnetic materials have the advantages of small size, low density, high information storage, easy processing and molding, low energy consumption and diversified structures, making it possible to become aerospace, microwave absorption stealth, optical and magnetic switches, Electromagnetic shielding, molecular electronics and high-density information storage materials.

At present, people's research on molecular-based magnets is mainly concentrated in the fields of nanomagnets, magnetic molecular switch materials and composite functional materials. Among them, the composite functional material means that the synthesized magnetic material has the properties of chirality, ferroelectricity, fluorescence, superconductivity and conductivity at the same time. Nanomagnets are materials that exhibit magnetic behavior on the nanoscale. They are mainly divided into single-molecule magnets, single-stranded magnets, single-ion magnets, and two paramagnetic ions bridged by diamagnetic metal or long-chain conjugated organic bridge compounds. The problems in these systems are: (1) The real application of these compounds is mainly restricted by the low relaxation temperature, and it is difficult to maintain their magnetic behavior at room temperature; (2) Long-chain ligands generally require multi-step synthesis, which gives The synthesis brings uncontrollability and poor solubility, which leads to difficulties in performance research; (3) The magnetic interaction of the compounds connected by the diamagnetic metal bridge is very weak; (4) The magnetic coupling effect increases with the increase of the chain length. Sharply reduced. Therefore, there is an urgent need to deepen the study of the magnetic structure-activity relationship, choose different metal ions and bridging ligands with excellent magnetic transfer ability, and design and synthesize nano-scale molecular-based magnetic materials from the source to effectively improve the relaxation of such compounds. temperature. The research of magnetic switch materials mainly focuses on the influence of external stimuli including light, heating, pressure, electric field and guest molecules on the magnetic properties of materials.

In order to overcome the limiting factors such as the decrease of the coupling strength between two paramagnetic ions as the distance increases and the difficulty in designing and synthesizing organic long-chain ligands, the electron transfer or delocalization characteristics of the intramolecular paramagnetic ions of mixed valence compounds are used. It is an important research direction to construct nano-scale molecular-based magnetic materials with strong magnetic interaction. Mixed valence compound refers to a compound containing two or more metal centers in which one element exists in more than one oxidation state. Based on the characteristics of intramolecular spin-electron delocalization of mixed-valence compounds, which may exhibit special optical, electrical, and magnetic properties, and have broad application prospects, some research groups have prepared magnetic materials with novel properties. In fact, the compounds they report are only short-distance (less than 0.5 nm) magnetic coupling between paramagnetic ions.

In addition to being closely related to the properties of paramagnetic ions, the magnetic properties of compounds also depend on the properties of bridging ligands. As a bridging ligand, it should not only have good coordination ability and excellent electron transfer ability, but also should be as short as possible. The cyanide bridge is one of the shortest diatomic bridges and has good electron transfer and magnetic conductivity. At present, most scientific researches on multinuclear compounds containing cyanide bridges mainly focus on compounds in which two paramagnetic metal ions are directly connected by a cyanide bridge. There are few studies on cyanide bridged polynuclear compounds that bridge two diamagnetic terminal metal ions on paramagnetic ions.

### SUMMARY OF THE DISCLOSURE

Based on the above-mentioned prior art, this invention provides a cyano-bridged metal organic compound with intramolecular magnetic transition and a preparation method and application thereof. The cyanide bridged polynuclear compounds of magnetic metal fragments, based on their electrochemical properties and magnetic properties, indicate that they can be used in molecular-based magnetic materials.

The preparation method is simple, the process conditions are easy to control, and the preparation cost is low.

The technical solutions adopted to achieve the above-mentioned objects of the present invention are:

1, A cyanide bridged metal organic compound with intramolecular magnetic transition, which is characterized in that its general structural formula is: [(L₂)(L₁)M₁ (NC)M₂(L₃)ₘ(CN)M₁(L1)(L2)](PF₆)ₙ;

L2 is cyclopentadiene anion or pentamethylcyclopentadiene anion;

L₁ can be bis(dimethylphosphine)methane, bis(diethylphosphine)methane, bis(dipropylphosphine)methane, bis(diisopropylphosphine)methane, bis(dibutylphosphine)methane, bis(diisopropyl)methane Butylphosphine) methane, bis(di-tert-butylphosphine)methane, bis(diphenylphosphine)methane, bis(dicyclopentylphosphino)methane, bis(dicyclohexylphosphine)methane, bis[(2-Methoxyphenyl) phenylphosphino]methane, 1,2-bis(dimethylphosphine)ethane, 1,2-bis(diethylphosphine)ethane, 1,2-bis(dipropylene) Phosphine) ethane, 1,2-bis(diisopropylphosphine)ethane, 1,2-bis(dibutylphosphine)ethane, 1,2-bis(diisobutylphosphine)ethane, 1,2-bis(di-tert-butylphosphine)ethane, 1,2-bis(dicyclopentylphosphino)ethane, 1,2-bis(dicyclohexylphosphino)ethane, 1,2-Bis(diphenylphosphine)ethane, 1,2-bis[(2-methoxyphenyl)phenylphosphino]ethane, 1,3-bis(dimethylphosphine)propane, 1,3-Bis(diethylphosphine)propane, 1,3-bis(dipropylphosphine)propane, 1,3-bis(diisopropylphosphine)propane, 1,3-bis(dibutylphosphine)propane, 1,3-bis(diisobutylphosphine) propane, 1,3-bis(di-tert-butylphosphine)propane, 1,2-bis(dicyclopentylphosphino)propane, 1,3-bis(di Cyclohexylphosphino) propane, 1,3-bis(diphenylphosphine)propane, 1,3-bis[(2-methoxyphenyl)phenylphosphino]propane, 1,4-bis(dimethyl Phosphine) butane, 1,4-bis(diethylphosphine)butane, 1,4-bis(dipropylphosphine)butane, 1,4-bis(diisopropylphosphine)butane, 1,4-bis(dibutylphosphine)butane, 1,4-bis(diisobutylphosphine)butane, 1,4-bis(di-tert-butylphosphine)butane, 1,2-bis(di Cyclopentylphosphino)butane, 1,4-bis(dicyclohexylphosphine)butane, 1,4-bis(diphenylphosphine)butane and 1,4-bis[(2-methoxybenzene))phenylphosphino]butane, one of them;

M₁ and M₂ are respectively one of manganese, technetium, rhenium, iron, ruthenium, osmium, cobalt, rhodium and iridium;

m=1, 2 or 4, when m is a different value, L3 is a different ligand, the details are as follows:

When m=4, L3 can be one of the follows: pyridine, 2-methylpyridine, 3-methylpyridine, 4-methylpyridine, 2-ethylpyridine, 3-ethylpyridine, 4-ethylpyridine, 1,5-Lutidine, 1,4-lutidine, 1,3-lutidine, 1,2-lutidine, 2,3-lutidine, 2,4-lutidine, 2,5-lutidine, 2-methoxypyridine, 3-methoxypyridine, 4-methoxypyridine, 2-nitropyridine, 3-nitropyridine, 4-nitropyridine, 2-Tert-butylpyridine, 3-tert-butylpyridine, 4-tert-butylpyridine, 2-fluoropyridine, 3-fluoropyridine, 4-fluoropyridine, 2-chloropyridine, 3-chloropyridine, 4-chloropyridine, 2-One of bromopyridine, 3-bromopyridine, 4-bromopyridine, 2-iodopyridine, 3-iodopyridine, 4-iodopyridine, 2-cyanopyridine, 3-cyanopyridine and 4-cyanopyridine; trimethyl phosphine, trimethoxy phosphine, dimethyl phosphine chloride, dimethyl phosphine bromide, triethyl phosphine, triethoxy phosphine, diethyl phosphine chloride, diethyl phosphine bromide, Dimethyl phenyl phosphine, methyl phenyl phosphine chloride, methyl phenyl phosphine bromide, dimethoxy phenyl phosphine, methoxy phenyl phosphine chloride, methoxy phenyl phosphine bromide, two Ethyl phenyl phosphine, ethyl phenyl phosphine chloride, ethyl phenyl phosphine bromide, diethoxy phenyl phosphine, dipropyl phenyl phosphine, propyl phenyl phosphine chloride, propyl phenyl bromide Phosphine, dipropoxyphenyl phosphine, diisopropyl phenyl phosphine, isopropyl phenyl phosphine chloride, isopropyl phenyl phosphine bromide, diisopropoxy phenyl phosphine, dibutoxy Phenyl phosphine, dibutyl phenyl phosphine, butyl phenyl phosphine chloride, butyl phenyl phosphine bromide, diisobutoxy phenyl phosphine, diisobutyl phenyl phosphine, isobutyl phenyl chloride Phosphine, isobutyl phenyl phosphine bromide, di-tert-butoxy phenyl phosphine, di-tert-butyl phenyl phosphine, tert-butyl phenyl phosphine chloride, tert-butyl phenyl phosphine bromide, dipentyl Phenylphosphine, pentylphenylphosphonium chloride, pentylphenylphosphonium bromide, bis(2-cyanoethyl)phenylphosphine, 2-cyanoethylphenylphosphonium chloride, 2-cyanoethyl Phenyl phosphine bromide, diphenyl methyl phosphine, diphenyl methoxy phosphine, diphenoxy methoxy phosphine, diphenoxy methyl phosphine, phenoxy methoxy phosphine chloride, benzene Oxyl methoxy phosphine bromide, diphenoxy methyl phosphine bromide, diphenoxy methyl phosphine chloride, diphenyl ethyl phosphine, diphenyl ethoxy phosphine, diphenoxy ethoxy Phosphine, diphenoxy ethyl phosphine, phenoxy ethoxy phosphine chloride, phenoxy ethoxy phosphine bromide, diphenoxy ethyl phosphine bromide, diphenoxy ethyl phosphine chloride, Diphenyl propyl phosphine, diphenyl propoxy phosphine, diphenoxy propoxy phosphine, diphenoxy propyl phosphine, phenoxy propoxy phosphine chloride, phenoxy propoxy bromide Phosphine, diphenoxypropyl phosphine bromide, diphenoxypropyl phosphine chloride, diphenyl isopropyl phosphine, diphenyl isopropoxy phosphine, diphenoxy isopropoxy phosphine, Diphenoxyisopropylphosphine, phenoxyisopropyloxyphosphonium chloride, phenoxyisopropyloxyphosphonium bromide, diphenoxyisopropylphosphonium bromide, diphenoxyisopropyl chloride Phosphine, diphenylbutylphosphine, diphenylbutoxyphosphine, diphenoxybutoxyphosphine, diphenoxybutylphosphine, phenoxybutoxyphosphine chloride, phenoxybutoxy Phosphine bromide, diphenoxy butyl phosphine bromide, diphenoxy butyl phosphine chloride, diphenyl isobutyl phosphine, diphenyl isobutoxy phosphine, diphenoxy isobutoxy Phosphine, diphenoxy isobutyl phosphine, phenoxy isobutoxy phosphine chloride, phenoxy isobutoxy phosphine bromide, diphenoxy isobutyl phosphine bromide, diphenoxy isobutyl Phosphine chloride, diphenyl tert-butyl phosphine, diphenyl tert-butoxy phosphine, diphenoxy tert-butoxy phosphine, diphenoxy tert-butyl phosphine, phenoxy tert-butoxy chlorination Phosphine, phenoxy iso-tert-oxy phosphine bromide, diphenoxy tert-butyl phosphine bromide, diphenoxy tert-butyl phosphine chloride, diphenyl pentyl phosphine, diphenyl pentyl oxy phosphine, Diphenoxypentyloxyphosphine, diphenoxypentylphosphine, phenoxypentyloxyphosphine chloride, phenoxypentyloxyphosphine bromide, diphenoxypentylphosphine bromide, diphenoxy Pentyl phosphine chloride, diphenyl isopentyl phosphine, diphenyl isopentyl phosphine, diphenoxy isopentyl phosphine, diphenoxy isopentyl phosphine, phenoxy isopentyl oxide Phosphine chloride, phenoxy isopentyl phosphine bromide, diphenoxy isopentyl phosphine bromide, diphenoxy isopentyl phosphine chloride, diphenyl tert-amyl phosphine, diphenyl tert Pentoxy phosphine, diphenoxy tert-pentyl phosphine, diphenoxy tert-pentyl phosphine, phenoxy tert-pentyloxy phosphine chloride, phenoxy iso-tert-oxy phosphine bromide, diphenoxy Tert-amyl phosphine bromide, diphenoxy tert-amyl phosphine chloride, di-o-methyl phenyl methyl phosphine, di-o-methyl phenyl methoxy phosphine, di-o-methyl phenoxy methoxy phosphine, Di-o-methylphenoxymethyl phosphine, o-methylphenoxy methoxy phosphine chloride, o-methyl phenoxy methoxy phosphonium bromide, di-o-methyl phenoxy methyl phosphonium bromide, Di-o-methylphenoxymethyl phosphine chloride, di-o-methyl phenyl ethyl phosphine, di-o-methyl phenyl ethoxy phosphine, di-o-methyl phenoxy ethoxy phosphine, di-o-methyl Phenoxyethyl phosphine, o-methylphenoxy ethoxy phosphine chloride, o-methylphenoxy ethoxy phosphonium bromide, di-o-methylphenoxy ethyl phosphonium bromide, di-o-methyl Phenoxyethyl phosphine chloride, di-o-methyl phenyl propyl phosphine, di-o-methyl phenyl propoxy phosphine, di-o-methyl phenoxy propoxy phosphine, di-o-methyl phenoxy Propyl phosphine, o-methylphenoxy propoxy phosphine chloride, o-methylphenoxy propoxy phosphonium bromide, di-o-methylphenoxy propyl phosphine bromide, di-o-methylphenoxy Propyl phosphine chloride, di-o-methyl phenyl isopropyl phosphine, di-o-methyl phenyl isopropoxy phosphine, di-o-methyl phenoxy isopropoxy phosphine, di-o-methyl phenoxy iso Propyl phosphine, o-tolu Phenoxyisopropyl phosphine chloride, di-o-methyl phenyl butyl phosphine, di-o-methyl phenyl butoxy phosphine, di-o-methyl phenoxy butoxy phosphine, di-o-methyl phenoxy Butyl phosphine, o-methylphenoxybutoxy phosphine chloride, o-methylphenoxybutoxy phosphonium bromide, di-o-methylphenoxybutyl phosphine bromide, di-o-methylphenoxy Butyl phosphine chloride, di-o-methyl phenyl isobutyl phosphine, di-o-methyl phenyl isobutoxy phosphine, di-o-methyl phenoxy isobutoxy phosphine, di-o-methyl phenoxy iso Butyl phosphine, o-methylphenoxy isobutoxy phosphine chloride, o-methylphenoxy isobutoxy phosphonium bromide, di-o-methylphenoxy isobutyl phosphine bromide, di-o-methyl Phenoxy isobutyl phosphine chloride, di-o-methyl phenyl tert-butyl phosphine, di-o-methyl phenyl tert-butoxy phosphine, di-o-methyl phenoxy tert-butoxy phosphine, di-o-methyl Phenoxy tert-butyl phosphine, o-methylphenoxy tert-butoxy phosphine chloride, o-methylphenoxy iso-tert-oxy phosphine bromide, di-o-methylphenoxy tert-butyl phosphine bromide, Di-o-methylphenoxy tert-butyl phosphine chloride, di-o-methyl phenyl pentyl phosphine, di-o-methyl phenyl pentyl phosphine, di-o-methyl phenoxy pentyl oxy phosphine, di-o-methyl Phenoxypentyl phosphine, o-methylphenoxypentyl phosphine chloride, o-methylphenoxypentyl phosphine bromide, di-o-methylphenoxypentyl phosphine bromide, di-o-methyl Phenoxypentyl phosphine chloride, di-o-methyl phenyl isopentyl phosphine, di-o-methyl phenyl isopentyl phosphine, di-o-methyl phenoxy isopentyl phosphine, di-o-methyl Phenoxy isopentyl phosphine, o-methylphenoxy isopentyl phosphine chloride, o-methylphenoxy isopentyl phosphine bromide, di-o-methylphenoxy isopentyl phosphine bromide, Di-o-methylphenoxy isopentyl phosphine chloride, di-o-methyl phenyl tert-pentyl phosphine, di-o-methyl phenyl tert-pentyl phosphine, di-o-methyl phenoxy tert-pentyl phosphine, Di-o-methylphenoxy tert-amyl phosphine, o-methylphenoxy tert-pentyloxy phosphine chloride, o-methylphenoxy tert-pentyloxy phosphonium bromide, di-o-methylphenoxy tert-amyl phosphine Phosphine bromide, di-o-methylphenoxy tert-amyl phosphine chloride, dimethyl phenyl methyl phosphine, dimethyl phenyl methoxy phosphine, dimethyl phenoxy methoxy phosphine, Dimethyl phenoxy methyl phosphine, m-methyl phenoxy methoxy phosphine chloride, m-methyl phenoxy methoxy phosphine bromide, dimethyl phenoxy methyl phosphine bromide, Dimethylphenoxymethyl phosphine chloride, dimethyl phenyl ethyl phosphine, dimethyl phenyl ethoxy phosphine, dimethyl phenoxy ethoxy phosphine, dimethyl M-methylphenoxyethyl phosphine, m-methylphenoxy ethoxy phosphonium chloride, m-methylphenoxy ethoxy phosphonium bromide, dimethylphenoxyethyl phosphonium bromide, dimethyl phenoxyethyl phosphine bromide Phenoxyethyl phosphine chloride, dimethyl phenyl propyl phosphine, dimethyl phenyl propoxy phosphine, dimethyl phenoxy propoxy phosphine, dimethyl phenoxy Propyl phosphine, m-methylphenoxy propoxy phosphine chloride, m-methylphenoxy propoxy phosphonium bromide, dimethyl phenoxy propyl phosphine bromide, dimethyl phenoxy Propyl phosphine chloride, dimethyl phenyl isopropyl phosphine, dimethyl phenyl isopropoxy phosphine, dimethyl phenoxy isopropoxy phosphine, dimethyl phenoxy iso Propyl phosphine, m-methylphenoxy isopropoxy phosphine chloride, m-methylphenoxy isopropoxy phosphine bromide, dimethyl phenoxy isopropyl phosphine bromide, dimethyl phenoxy isopropyl phosphine bromide Phenoxyisopropyl phosphine chloride, dimethyl phenyl butyl phosphine, dimethyl phenyl butoxy phosphine, dimethyl phenoxy butoxy phosphine, dimethyl phenoxy Butyl phosphine, m-methylphenoxybutoxy phosphine chloride, m-methylphenoxybutoxy phosphonium bromide, dimethylphenoxybutyl phosphine bromide, dimethylphenoxy Butyl phosphine chloride, dimethyl phenyl isobutyl phosphine, dimethyl phenyl isobutoxy phosphine, dimethyl phenoxy isobutoxy phosphine, dimethyl phenoxy iso Butyl phosphine, m-methylphenoxy isobutoxy phosphine chloride, m-methylphenoxy isobutoxy phosphonium bromide, dimethyl phenoxy isobutyl phosphonium bromide, dimethyl phenoxy isobutyl phosphine bromide Phenoxy isobutyl phosphine chloride, dimethyl phenyl tert-butyl phosphine, dimethyl phenyl tert-butoxy phosphine, dimethyl phenoxy tert-butoxy phosphine, dimethyl phenyl Phenoxy tert-butyl phosphine, m-methylphenoxy tert-butoxy phosphine chloride, m-methylphenoxy iso-tert-oxy phosphine bromide, dimethylphenoxy tert-butyl phosphine bromide, Dim-methylphenoxy tert-butyl phosphine chloride, dimethyl phenylpentyl phosphine, dimethyl phenyl pentyl phosphine, dimethyl phenoxy pentyl phosphine, dimethyl Phenoxypentyl phosphine, m-methylphenoxypentyl phosphine chloride, m-methylphenoxypentyl phosphine bromide, dimethylphenoxypentyl phosphine bromide, dimethyl phenoxypentyl phosphine bromide Phenoxypentyl phosphine chloride, dimethyl phenyl isopentyl phosphine, dimethyl phenyl isopentyl phosphine, dimethyl phenoxy isopentyl phosphine, dimethyl Phenoxy isopentyl phosphine, m-methylphenoxy isopentyl phosphine chloride, m-methylphenoxy isopentyl phosphine bromide, dimethyl phenoxy isopentyl phosphine bromide, Dim-methylphenoxy isopentyl phosphine chloride, dimethyl phenyl tert-pentyl phosphine, dimethyl phenyl tert-pentyl phosphine, dimethyl phenoxy tert-pentyl phosphine, Dim-methylphenoxy tert-amyl phosphine, m-methylphenoxy tert-amyloxy phosphine chloride, m-methylphenoxy tert-amyloxy phosphonium bromide, dimethylphenoxy tert-amyl phosphine Phosphine bromide, di-m-methylphenoxy tert-amyl phosphine chloride, di-p-tolyl methyl phosphine, di-p-tolyl methoxy phosphine, di-p-tolyl oxy methoxy phosphine, two-p-tolyl Tolyloxymethyl phosphine, p-tolyloxy methoxy phosphine chloride, p-tolyloxy methoxy phosphine bromide, di-p-tolyloxy methyl phosphine bromide, di-p-tolyloxy Methyl phosphine chloride, di-p-tolyl ethyl phosphine, di-p-tolyl ethoxy phosphine, di-p-tolyloxy ethoxy phosphine, di-p-tolyl oxy ethyl phosphine, p-tolyl oxygen Ethoxy phosphine chloride, p-tolyloxy ethoxy phosphonium bromide, di-p-tolyloxy ethyl phosphonium bromide, di-p-tolyloxy ethyl phosphine chloride, di-p-tolyl propyl Phosphine, di-p-tolyl propoxy phosphine, di-p-tolyloxy propoxy phosphine, di-p-tolyloxy propyl phosphine, p-tolyloxy propoxy phosphine chloride, p-tolyloxy Propoxy phosphine bromide, di-p-tolyloxy propyl phosphine bromide, di-p-tolyloxy propyl phosphine chloride, di-p-tolyl isopropyl phosphine, di-p-tolyl isopropoxy Phosphine, di-p-tolyloxy isopropoxy phosphine, di-p-tolyloxy isopropyl phosphine, p-tolyloxy isopropoxy phosphine chloride, p-tolyloxy isopropoxy bromide Phosphine, di-p-tolyloxy isopropyl phosphine bromide, di-p-tolyloxy isopropyl phosphine chloride, di-p-tolyl butyl phosphine, di-p-tolyl butoxy phosphine, di-p-toluene Oxybutoxy phosphine, di-p-tolyloxy butyl phosphine, p-tolyloxy butoxy phosphine chloride, p-tolyloxy butoxy phosphine bromide, di-p-tolyloxy butyl Phosphine bromide, two-p-tolyloxybutyl phosphine chloride, two-p-tolyl isobutyl phosphine, two-p-tolyl isobutoxy phosphine, two P-tolyloxy isobutyl phosphine, p-tolyloxy isobutoxy phosphine chloride, p-tolyloxy isobutoxy phosphonium bromide, two p-tolyloxy isobutyl phosphine bromide, two P-tolyloxy isobutyl phosphine chloride, di-p-tolyl tert-butyl phosphine, di-p-tolyl tert-butoxy phosphine, di-p-tolyloxy tert-butoxy phosphine, di-p-tolyl oxygen Tert-butyl phosphine, p-tolyloxy tert-butoxy phosphine chloride, p-tolyloxy iso-tert-oxy phosphonium bromide, di-p-tolyloxy tert-butyl phosphine bromide, di-p-tolyloxy Tert-butyl phosphine chloride, di-p-tolyl pentyl phosphine, di-p-tolyl pentyl phosphine, di-p-tolyl oxypentyl phosphine, di-p-tolyl pentyl phosphine, p-toluene Oxypentyloxy phosphine chloride, p-tolyloxy pentyl phosphine bromide, di-p-tolyloxy pentyl phosphonium bromide, di-p-tolyloxy pentyl phosphine chloride, di-p-tolyl 2-methyl isopentyl phosphine, di-p-tolyl isopentoxy phosphine, di-p-tolyloxy isopentyl phosphine, di-p-tolyloxy isopentyl phosphine, p-tolyloxy isopentoxy chloride Phosphine bromide, p-tolyloxy isopentyl phosphine bromide, di-p-tolyloxy isopentyl phosphine bromide, Di-p-tolyloxy isopentyl phosphine chloride, di-p-tolyl tert-pentyl phosphine, di-p-tolyl tert-pentyl phosphine, di-p-tolyl oxy tert-pentyl phosphine, di-p-tolyl Tert-pentyl phosphine, p-tolyloxy tert-pentyl phosphine chloride, p-tolyloxy tert-pentyl phosphine bromide, two-p-tolyloxy tert-pentyl phosphine bromide, two-p-tolyl Oxy tert-amyl phosphine chloride, diphenyl (trimethylsilyl) phosphine, phenyl (trimethylsilyl) phosphine chloride, phenyl (trimethylsilyl) phosphine bromide, allyl Diphenyl phosphine, allyl phenyl phosphine chloride, allyl phenyl phosphine bromide, diphenyl cyclohexyl phosphine, diphenoxy cyclohexyl phosphine, phenoxy cyclohexyl phosphine chloride, phenoxy Cyclohexyl phosphine bromide, phenylcyclohexyl phosphine bromide, phenylcyclohexyl phosphine chloride, bis(3,5-dimethylphenyl)methylphosphine, (3,5-dimethylphenyl)methyl Phosphine chloride, (3,5-dimethylphenyl)methylphosphonium bromide, bis(3,5-dimethylphenyl)methoxyphosphine, bis(3,5-dimethylphenyl)) Methoxy phosphine bromide, bis(3,5-dimethylphenyl) methoxyphosphine chloride, bis(3,5-dimethylphenyl)ethyl phosphine, (3,5-dimethylphenyl) Phenyl) ethyl phosphine chloride, (3,5-dimethylphenyl) ethyl phosphine bromide chloride, bis(3,5-dimethylphenyl) ethoxyphosphine, (3,5-Dimethylphenyl)ethoxyphosphonium bromide, (3,5-dimethylphenyl)ethoxyphosphonium chloride, bis(3,5-dimethylphenyl)propylphosphine, (3,5-Dimethylphenyl)propylphosphonium chloride, (3,5-dimethylphenyl)propylphosphonium bromide chloride, bis(3,5-dimethylphenyl)propoxyphosphine, (3,5-Dimethylphenyl)propoxyphosphonium bromide, (3,5-Dimethylphenyl)propoxyphosphonium chloride, bis(3,5-dimethylphenyl)iso Propylphosphine, (3,5-dimethylphenyl) isopropyl phosphine chloride, (3,5-dimethylphenyl) isopropyl phosphine bromide chloride, bis(3,5-dimethylphenyl) Phenyl)isopropoxyphosphine, (3,5-dimethylphenyl)isopropoxyphosphine bromide, (3,5-dimethylphenyl)isopropoxyphosphine chloride, bis(3,5-Dimethylphenyl)butylphosphine, (3,5-dimethylphenyl)butylphosphine chloride, (3,5-dimethylphenyl)

When m=2, L3 is one of 2,2′-dipyridine, 3-methyl-2,2′-dipyridine, 4-methyl-2,2′-dipyridine, 5-methyl-2,2′-Bipyridine, 6-Methyl-2,2′-Bipyridine, 4-Chloro-2,2′-Bipyridine, 5-Chloro-2,2′-Bipyridine, 6-Chloro-2,2′-bipyridine, 4-bromo-2,2′-bipyridine, 5-bromo-2,2′-bipyridine, 6-bromo-2,2′-bipyridine, 4-methoxy-2,2′-bipyridine, 5-methoxy-2,2′-bipyridine, 6-methoxy-2,2′-bipyridine, 4-cyano-2,2′-bipyridine, 5-cyano-2,2′-bipyridine, 6-cyano-2,2′-bipyridine, 4-tert-butyl-2,2′-bipyridine, 5-tert-butyl-2,2′-Bipyridine, 6-tert-butyl-2,2′-bipyridine, 4,4′-dimethyl-2,2′-bipyridine, 5,5′-dimethyl-2,2′-Bipyridine, 6,6′-dimethyl-2,2′-bipyridine, 4,4′-dicyano-2,2′-bipyridine, 5,5′-dicyano-2,2′-Bipyridine, 6,6′-dicyano-2,2′-bipyridine, 4,4′-dimethoxy-2,2′-bipyridine, 5,5′-dimethoxy-2,2′-bipyridine, 6,6′-dimethoxy-2,2′-bipyridine, 4,4′-di-tert-butyl-2,2′-bipyridine, 5,5′-dipyridine Tert-butyl-2,2′-bipyridine, 6,6′-di-tert-butyl-2,2′-bipyridine, 4,4′-dichloro-2,2′-bipyridine, 5,5′-Dichloro-2,2′-bipyridine, 6,6′-dichloro-2,2′-bipyridine, 4,4′-dibromo-2,2′-bipyridine, 5,5′-dipyridine Bromo-2,2′-bipyridine, 6,6′-dibromo-2,2′-bipyridine, 2,2′-biquinoline, 4,4′-diphenyl-2,2′-bipyridine Pyridine, 1,10-phenanthroline, 2-chloro-1,10-phenanthroline, 3-chloro-1,10-phenanthroline, 4-chloro-1,10-phenanthroline, 5-chloro-1,10-phenanthroline, 2-bromo-1,10-phenanthroline, 3-bromo-1,10-phenanthroline, 4-bromo-1,10-phenanthroline Phenanthroline, 5-bromo-1,10-phenanthroline, 2-methyl-1,10-phenanthroline, 3-methyl-1,10-phenanthroline, 4-methyl-1,10-phenanthroline, 5-methyl-1,10-phenanthroline, 2-methoxy-1,10-phenanthroline, 3-methoxy-1,10-phenanthroline, 4-Methoxy-1,10-phenanthroline, 5-methoxy-1,10-phenanthroline, 2-cyano-1,10-phenanthroline, 3-cyano-1,10-phenanthroline, 4-cyano-1,10-phenanthroline, 5-cyano-1,10-phenanthroline, 2-nitro-1,10-phenanthroline, 3-nitro-1,10-phenanthroline, 4-nitro-1,10-phenanthroline, 5-nitro Base-1,10-phenanthroline, 2-tert-butyl-1,10-phenanthroline, 3-tert-butyl-1,10-phenanthroline, 4-tert-butyl-1,10-Phenanthroline, 5-tert-butyl-1,10-phenanthroline, 2,9-dimethyl-1,10-phenanthroline, 3,8-dimethyl-1,10-Phenanthroline, 4,7-dimethyl-1,10-phenanthroline, 5,6-dimethyl-1,10-phenanthroline, 3,4,7,8-tetramethyl-1,10-phenanthroline, 2,9-dichloro-1,10-phenanthroline, 3,8-dichloro-1,10-phenanthroline, 4,7-dichloro-1,10-phenanthroline, 5,6-dichloro-1,10-phenanthroline, 3,4,7,8-tetrachloro-1,10-phenanthroline, 2,9-dibromo-1,10-phenanthroline, 3,8-dibromo-1,10-phenanthroline, 4,7-dibromo-1,10-phenanthroline, 5,6-dibromo-1,10-phenanthroline, 3,4,7,8-tetrabromo-1,10-phenanthroline, 2,9-dimethoxy-1,10-phenanthroline, 3,8-Dimethoxy-1,10-phenanthroline, 4,7-dimethoxy-1,10-phenanthroline, 5,6-dimethoxy-1,10-phenanthroline, 3,4,7,8-Tetramethoxy-1,10-phenanthroline, 2,9-dicyano-1,10-phenanthroline, 3,8-dicyano-1,10-Phenanthroline, 4,7-dicyano-1,10-phenanthroline, 5,6-dicyano-1,10-phenanthroline, 3,4,7,8-tetracyano 1,10-phenanthroline, 2,9-dinitro-1,10-phenanthroline, 3,8-dinitro-1,10-phenanthroline, 4,7-di Nitro-1,10-phenanthroline, 5,6-dinitro-1,10-phenanthroline, 3,4,7,8-tetranitro-1,10-phenanthroline, Bis(dimethylphosphine)methane, bis(diethylphosphine)methane, bis(dipropylphosphine)methane, bis(diisopropylphosphine)methane, bis(dibutylphosphine)methane, bis(diisopropyl)methane Butylphosphine) methane, bis(di-tert-butylphosphine)methane, bis(diphenylphosphine)methane, bis(dicyclopentylphosphino)methane, bis(dicyclohexylphosphino)methane, bis(diphenyl) Phosphine) methane, bis[(2-methoxyphenyl)phenylphosphino]methane, 1,2-bis(dimethylphosphine)ethane, 1,2-bis(diethylphosphine)ethane 1,2-bis(dipropylphosphine)ethane, 1,2-bis(diisopropylphosphine)ethane, 1,2-bis(dibutylphosphine)ethane, 1,2-bis(Diisobutylphosphine) ethane, 1,2-bis(di-tert-butylphosphine)ethane, 1,2-bis(dicyclopentylphosphino)ethane, 1,2-bis(dicyclohexyl) Phosphine) ethane, 1,2-bis(diphenylphosphine)ethane, 1,2-bis[(2-methoxyphenyl)phenylphosphino]ethane, 1,3-bis(diphenylphosphine)ethane Methylphosphine) propane, 1,3-bis(diethylphosphine) propane, 1,3-bis(dipropylphosphine) propane, 1,3-bis(Diisopropylphosphine) propane, 1,3-bis(dibutylphosphine)propane, 1,3-bis(diisobutylphosphine)propane, 1,3-bis(di-tert-butylphosphine)propane, 1,2-bis(dicyclopentylphosphino)propane, 1,3-bis(dicyclohexylphosphino)propane, 1,3-bis(diphenylphosphine)propane, 1,3-bis[(2-Methoxyphenyl)phenylphosphino]propane, 1,4-bis(dimethylphosphine)butane, 1,4-bis(diethylphosphine)butane, 1,4-bis(di Propylphosphine) butane, 1,4-bis(diisopropylphosphine)butane, 1,4-bis(dibutylphosphine)butane, 1,4-bis(diisobutylphosphine)butane, 1,4-bis(di-tert-butylphosphino)butane, 1,2-bis(dicyclopentylphosphino)butane, 1,4-bis(dicyclohexylphosphino)butane, 1,4-One of bis(diphenylphosphine)butane and 1,4-bis[(2-methoxyphenyl)phenylphosphino]butane;

When m=1, L3 is 2,2′:6′,2″:6″,2′″-tetrabipyridine, 2-methyl-2,2′:6′,2″:6″,2′″-tetrapyridine, 3-methyl-2,2′:6′,2″:6″,2″-tetrapyridine, 4-methyl-2,2′:6′,2″:6″,2′″-tetrabipyridine, 5-methyl-2,2′:6′,2″:6″,2′″-tetra Bipyridine, 6-methyl-2,2′:6′,2″:6″,2′″-tetrabipyridine, 7-methyl-2,2′:6′,2″:6″,2′″-tetrapyridine, 8-methyl-2,2′:6′,2″:6″,2′-tetrapyridine, 2-methoxy-2,2′:6′,2″:6″,2′″-tetrabipyridine, 3-methoxy-2,2′:6′,2″:6″,2′″-Tetrapyridine, 4-methoxy-2,2′:6′,2″:6″,2′″-tetrapyridine, 5-methoxy-2,2′:6′,2″:6″,2′″-Tetrapyridine, 6-Methoxy-2,2′:6′,2″:6″,2″-Tetrapyridine, 7-Methoxy-2,2′:6′,2″:6″,2′″-tetrabipyridine, 8-methoxy-2,2′:6′,2″:6″,2′″-tetrapyridine, 2-nitro-2,2′:6′,2″:6″,2′″-tetrapyridine, 3-nitro-2,2′:6′,2″:6″,2″-tetrabipyridine, 4-nitro-2,2′:6′,2″:6″,2′″-tetrabipyridine, 5-nitro-2,2′:6′,2″:6″,2′″-tetrabipyridine, 6-nitro-2,2′:6′,2″:6″,2′″-tetrapyridine, 7-nitro-2,2′:6′,2″:6″,2″-tetrapyridine, 8-nitro-2,2′:6′,2″:6″,2′″-tetrabipyridine, 2-cyano-2,2′:6′,2″:6″,2′″-tetrabipyridine, 3-cyano-2,2′:6′,2″:6″,2′″-tetrabipyridine, 4-cyano-2,2′:6′,2″:6″,2′-tetrapyridine, 5-cyano-2,2′:6′,2″:6″,2′″-tetrapyridine, 6-cyano-2,2′:6′,2″:6″,2″-tetrabipyridine, 7-cyano-2,2′:6′,2″:6″,2′″-tetrabipyridine, 8-cyano-2,2′:6′,2″:6″,2′″-tetrabipyridine, 2-chloro-2,2′:6′,2″:6″,2′-tetrabipyridine, 3-chloro-2,2′:6′,2″:6″, T″-tetrabipyridine, 4-chloro-2,2′:6′,2″:6″,2′″-Tetrapyridine, 5-chloro-2,2′:6′,2″:6″,2′″-tetrabipyridine, 6-chloro-2,2′:6′,2″:6″,2′″-Tetrapyridine, 7-chloro-2,2′:6′,2″:6″,2′″-Tetrapyridine, 8-chloro-2,2′:6′,2 “:6”,2″-tetrapyridine, 2-bromo-2,2′:6′,2″:6″,2′″-tetrapyridine, 3-bromo-2,2′:6′,2″:6″,2′″-tetrabipyridine, 4-bromo-2,2′:6′,2″:6″,2′″-tetra Bipyridine, 5-bromo-2,2′:6′,2″:6″,2′″-tetrabipyridine, 6-bromo-2,2′:6′,2″:6″,2′″-tetrabipyridine, 7-bromo-2,2′:6′,2″:6″,2′″-tetrabipyridine and 8-bromo-2,2′:6′,2″:6″,2′″-one of tetrapyridine;

n=2, 3, or 4.

A method for preparing a cyanide-bridged metal organic compound with intramolecular magnetic transition according to claim 1, it contains the following steps:

Under argon atmosphere, add M₁(L₃)ₘ(CN)₂ to alcohol, nitrile or ketone solvent, then M₂(L₁)(L₂)X was added, where X is Cl, Br or 1. After reacting the resulting mixture at 50-120° C. for 5-24 hours, NH₄PF₆ is then added to prepare a diamagnetic cyanide bridged metal organic compound [(L₂)(L₁)M₁(NC-μ)M₂(L₃)ₘ(μ-CN)M₁(L₁)(L₂)](PF₆)₂;

Dissolve [(L₂)(L₁)M₁(NC)M₂(L₃)ₘ(CN)M₁(L₁)(L₂)](PF₆)₂ in the halogenated hydrocarbon solvent, then oxidant A was added, reactin at 20-80° C. for 1-12 hours, the paramagnetic cyanide bridged metal organic compound [(L₂)(L₁)M₁(NC)M₂(L₃)ₘ(CN)M₁(L₁)(L₂)](PF₆)₃ was obtained;

Dissolve [(L₂)(L₁)M₁(NC)M₂(L₃)ₘ(CN)M₁(L₁)(L₂)](PF₆)₃ in a halogenated hydrocarbon solvent, oxidant B was added. Reaction at 20-80° C. for 1-12 hours to prepare antiferromagnetic or ferromagnetic cyanide bridged metal organic compound [(L₂)(L₁)M₁(NC)M₂(L₃)ₘ(CN)M₁(L₁)(L₂)](PF₆)₄.

The preparation method of cyano-bridged metal organic compound with intramolecular magnetic transition according to claim 2, it is characterized in that: the alcohol solvent is one of methanol, ethanol, propanol, isopropanol, butanol, tertiary One of butanol, 1-pentanol, 2-pentanol, 3-pentanol, 1-hexanol, 2-hexanol and 3-hexanol. Nitrile solvent is one of acetonitrile, propionitrile, butyronitrile and valeronitrile. Ketone solvents is one of acetone, methyl ethyl ketone, n-pentanone and hexanone.

The preparation method of cyanide bridged metal organic compound with intramolecular magnetic transition according to claim 2, characterized in that: the halogenated hydrocarbon is monochloromethane, dichloromethane, trichloromethane, tetrachloride One of carbon, ethyl chloride, 1,2-dichloroethane, 1-chloropropane, 2-chloropropane, and 1,2-dichloropropane.

The preparation method of cyanide bridged metal organic compound with intramolecular magnetic transition according to claim 2, characterized in that: the oxidant A and the oxidant B is one of oxyacetic acid, sodium dichromate, chromic acid, peroxy Ammonium sulfate, sodium hypochlorite, sodium percarbonate, sodium perborate, potassium perborate, Na₂O₂, K₂O₂, MgO₂, CaO₂, BaO₂, H₂O₂, F₂, Cl₂, O₂, O₃, Br₂, I₂, S, Si, KMnO₄, KClO₃, H₂SO₄, HNO₃, MnO₂, FeCl₃, Fe(NO₃)₃, Fe(ClO₄)₃, Fe(BF₄)₃, Fe(PF₆)₃, CpFe(BF₄), CpFe(PF₆), RuCl₃, Ru(NO₃)₃, Ru(ClO₄)₃, Ru(BF₄)₃, Ru(PF₆)₃, CpRu(BF₄), CpRu(PF₆), Cu(ClO₄)₂, CuCl₂, Cu(PF₆)₂, Cu(BF₄)₂, Cu(NO₃)₂, CpCu(BF₄), CpCu(PF₆), AgNO₃, AgPF₆ and AgBF₄.

The preparation method of cyanide bridged metal organic compound with intramolecular magnetic transition according to claim 2, characterized in that: The molar ratio of M₁(L₃)m(CN)₂, M₂(L₁)(L₂)X and NH₄PF₆ is 1:1.01-4.99:1.02-4.99, [(L2)(L1)M1(NC)M2(L3)m(CN)M1(L1)(L2)](PF6)2 and oxidant A The ratio of, [(L₂)(L₁)M₁(NC)M₂(L₃)ₘ(CN)M₁(L₁)(L₂)](PF₆)₂ and oxidant A is 1:0.49-1.99, the molar ratio of [(L₂)(L₁)M₁(NC)M₂(L₃)ₘ(CN)M₁(L₁)(L₂)](PF₆)₃ to oxidant B is 1:0.99-3.99.

The application of a cyanide bridged metal organic compound with intramolecular magnetic transition as a magnetic material.

Compared with the prior art, the present invention has the following beneficial effects and advantages:

1. The currently prepared nano-scale molecular-based magnetic materials are mainly single-molecule magnets, single-stranded magnets, single-ion magnets, and two paramagnetic ions bridged by diamagnetic metal or long-chain conjugated organic bridge compounds, but these have two paramagnetic The coupling strength between ions decreases with the increase of the distance and the difficulty of designing and synthesizing organic long-chain ligands. The present invention utilizes the electron transfer or delocalization characteristics between paramagnetic metal ions in the molecules of mixed valence compounds. Construct nano-scale molecular-based magnetic materials with strong magnetic interaction.

2. The structure of the cyano-bridged metal organic compound prepared by the present invention can be oxidized in the same molecule, and the compound can be changed from diamagnetic to paramagnetic or antiferromagnetic. Therefore, the cyano-bridged metal organic compound can be used as a magnetic material, Can be potential applications in molecular electronic equipment, energy saving, switchable molecular switches and information storage.

3. The cyanide-bridged metal organic compound prepared by the present invention is a cyanide bridged polynuclear compound that bridges two diamagnetic metal fragments through a cyano group on a paramagnetic ion, and their electrochemical properties and magnetic properties have been studied. The results show that it can Used in the application of molecular-based magnetic materials.

4. The preparation method of the present invention is simple, the process conditions are easy to control, the preparation cost is low, and the prepared cyano-bridged metal organic compound has a controllable structure, good crystal form and high purity.

### BRIEF DESCRIPTION OF THE DRAWINGS

FIG. 1 is the crystal structure of the cation of trans-[Cp(dppe)Fe(NC)Ru(^{tbu}py)₄(CN)Fe(dppe)Cp][PF₆]. (n=2, 3, 4) prepared in Example 1.

FIG. 2 is the cyclic voltammogram of trans-[Cp(dppe)Fe(NC)Ru(^{tbu}py)₄(CN)Fe(dppe)Cp][PF₆]. (dissolved in dichloromethane) prepared in Example 1.

FIG. 3 is the cyclic voltammogram of trans-[Cp(dppe)Fe(NC)Ru(^{tbu}py)₄(CN)Fe(dppe)Cp][PF₆]. (dissolved in acetonitrile) prepared in Example 1.

FIG. 4 is the infrared spectrum of trans-[Cp(dppe)Fe(NC)Ru(^{thu}py)₄(CN)Fe(dppe)Cp][PF₆]. (n=2, 3, 4) prepared in Example 1. 1 represents trans-[Cp(dppe)Fe(NC)Ru(^{tbu}py)₄(CN)Fe(dppe)Cp][PF₆]₂, 2 represents trans-[Cp(dppe)Fe(NC)Ru(^{tbu}py)₄(CN)Fe(dppe)Cp][PF₆]₃, 3 represents trans-[Cp(dppe)Fe(NC)Ru(^{tbu}py)₄(CN)Fe(dppe)Cp][PF₆]₄.

FIG. 5 is the electronic absorption spectrum of trans-[Cp(dppe)Fe(NC)Ru(^{tbu}py)₄(CN)Fe(dppe)Cp][PF₆]. (n=2, 3, 4) prepared in Example 1. 1 represents trans-[Cp(dppe)Fe(NC)Ru(^{tbu}py)₄(CN)Fe(dppe)Cp][PF₆]₂, 2 represents trans-[Cp(dppe)Fe(NC)Ru(^{tbu}py)₄(CN)Fe(dppe)Cp][PF₆]₃, 3 represents trans-[Cp(dppe)Fe(NC)Ru(^{tbu}py)₄(CN)Fe(dppe)Cp][PF₆]₄.

FIG. 6 is the solid EPR spectrum of trans-[Cp(dppe)Fe(NC)Ru(^{tbu}py)₄(CN)Fe(dppe)Cp][PF₆]. (n=2, 3, 4) prepared in Example 1.

1 represents trans-[Cp(dppe)Fe(NC)Ru(^{tbu}py)₄(CN)Fe(dppe)Cp][PF₆]₂, 2 represents trans-[Cp(dppe)Fe(NC)Ru(^{tbu}py)₄(CN)Fe(dppe)Cp][PF₆]₃, 3 represents trans-[Cp(dppe)Fe(NC)Ru(^{tbu}py)₄(CN)Fe(dppe)Cp][PF₆]₄.

FIG. 7 is the solid EPR spectra of trans-[Cp(dppe)Fe(NC)Ru(^{tbu}py)₄(CN)Fe(dppe)Cp][PF₆]₄ prepared in Example 1 at different temperatures.

FIG. 8 is the temperature-varying magnetic susceptibility curve of trans-[Cp(dppe)Fe(NC)Ru(^{tbu}py)₄(CN)Fe(dppe)Cp][PF₆] and trans-[Cp(dppe)Fe(NC)Ru(^{tbu}py)₄(CN)Fe(dppe)Cp][PF₆]₃.

FIG. 9 is the temperature-varying magnetic susceptibility curve of trans-[Cp(dppe)Fe(NC)Ru(^{tbu}py)₄(CN)Fe(dppe)Cp][PF₆]₄ prepared in Example 1.

### DETAILED DESCRIPTION OF EMBODIMENTS

The invention will be described in detail below in conjunction with specific embodiments. The following embodiments are only used to illustrate the present invention and not to limit the scope of the present invention.

### Example 1

### trans-[Cp(dppe)Fe^{II}(NC)Ru^{II}(^{tbu}py)⁴(CN)Fe^{II}(dppe)Cp][PF₆]₂.3CH₂Cl₂

Under argon atmosphere, a mixture of trans-Ru^{II}(^{tbu}py)₄(CN)₂ (100 mg, 0.144 mmol) and CpFe^{II}(dppe)(NCCH₃)Br (186 mg, 0.290 mmol) was added to CH₃OH (10 ml) at room temperature, resulting in a red solution. And the mixture stirred at 60° C. for 6 h, NH₄PF₆ (51.7 mg, 0.317 mmol) was then added to the above red reaction solution. A red precipitate appeared immediately and was collected. Red prism crystals 1 (121 mg, 37%) suitable for X-ray diffraction analysis were obtained from a mixed solution of dichloromethane and ethyl ether (1:3, 40 ml) at room temperature. Anal. Calcd for C₁₀₀H₁₁₀F₁₂Fe₂N₆PF₆Ru: C, 59.38; H, 5.48; N, 4.16%. Found: C, 58.84; H, 5.71; N, 4.12%. IR (ν_{CN}, KBr pellet, cm⁻¹): 2071. UV-vis (CH₃CN), λₘₐₓ, nm (ε, dm³ mol⁻¹ cm⁻¹): 476 (1214). MS, m/z: 519.5 [Fe^{II}(dppe)Cp]+, 1212.3 [1-Fe^{II}(dppe)Cp-2PF₆]⁺, 1876.4 [1-PF₆]⁺.

### trans-[Cp(dppe)Fe^{III}(NC)Ru^{II}(^{tbu}py)⁴(CN)Fe^{II}(dppe)Cp][PF₆]₃.2C₃H₈O.H₂O

Cp₂Fe^{III}(PF₆) (14.6 mg, 0.044 mmol) was added to a solution of 1 (100 mg, 0.044 mol) in dichloromethane (10 ml) at room temperature. The mixture was stirred at 30° C. for 3 h and concentrated to 2 ml under reduced pressure, and then diethyl ether (20 ml) was added and a red precipitate was obtained. The resultant residue was dissolved in a mixed solution of dichloromethane (10 ml), diethyl-ether (30 ml) and 2-propanol (1 ml), to give 2 as red crystals (27.2 mg, 27%). Anal. Calcd for C₁₀₆H₁₂₈F₁₈Fe₂N₆O₃P₇Ru: C, 55.22; H, 5.60; N, 3.64%. Found: C, 55.33; H, 5.42; N, 3.53%. IR (ν_{CN}, KBr pellet, cm⁻¹): 2068, 2011. UV-vis (CH₃CN), λₘₐₓ, nm (ε, dm³ mol⁻¹ cm⁻¹): 465 (1468), 957 (2381). MS, m/z: 519.8 [CpFe^{II}(dppe)]⁺, 1212.1 [2-CpFe^{III}(dppe)-3PF₆]+, 1359.6 [2-CpFe^{II}(dppe)-2PF₆]⁺, 2021.1 [2-PF₆]⁺.

### trans-[Cp(dppe)Fe^{III}(NC)Ru^{II}(^{tbu}py)₄(CN)Fe^{III}(dppe)Cp][PF₆]₄.3 C₃H₆O.3CH₃CN

To a solution of 2 (100.0 mg, 0.044 mmol) in dichloromethane (10 ml), AgPF₆ (12.2 mg, 0.048 mmol) was added at room temperature. The solution changed immediately from red to brown and was stirred for another 3 h at 30° C. and concentrated under a reduced pressure to obtain a black brown precipitate. The black brown precipitate was collected, and washed with a little dichloromethane and ethyl ether. Deep brown prism crystals of 3 (37.4 mg, 32%) suitable for single crystal X-ray diffraction analysis were grown by layering diethyl ether (30 ml) on the acetone (10 ml) solution of the precipitate at room temperature in the dark. Anal. Calcd for C₁₁₅H₁₄₃F₂₄Fe₂N₉O₃P₈Ru: C, 52.80; H, 5.51%; N, 4.82%. Found: C, 52.94; H, 5.43; N, 4.54%. IR (ν_{c}\ᵣ, KBr pellet, cm⁻¹): 2018. UV-vis (CH₃CN), λ_{max,nm} (ε, dm³ mol⁻¹ cm⁻¹): 468(1980), 780(5573). MS, m/z: 1357.2 [3-CpFe^{III}(dppe)-3PF₆]⁺, 2166.0 [3-PF₆]⁺.

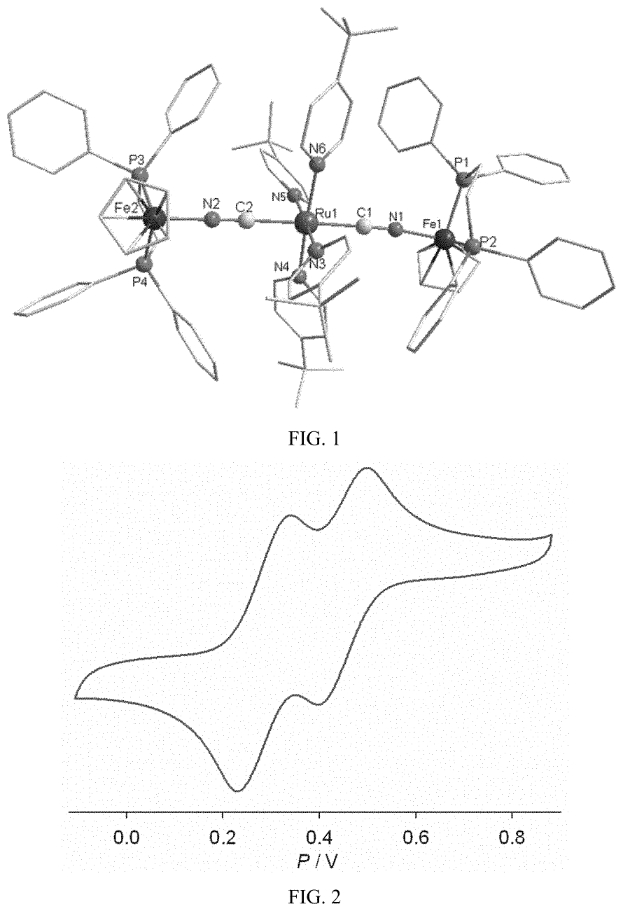

The trans-[Cp(dppe)Fe(NC)Ru(^{tbu}py)₄(CN)Fe(dppe)Cp][PF₆]. (n=2, 3, 4) prepared in this example was mixed in acetone and ether, etc. After recrystallization in a solvent, a crystal suitable for X-ray single crystal diffraction is obtained, which is subjected to single crystal X-ray diffraction analysis. The crystal structure diagram of the cation is shown in FIG. 1. It can be seen from FIG. 1 that the cation skeleton is a The trans linear trinuclear compound is two CpFe(dppe) fragments connected in trans to the central Ru(^{tbu}py)₄(CN)₂ fragment through a cyano bridge. The metal Ru in the middle is a deformed six-coordinate octahedral coordination environment, which is occupied by four nitrogen atoms from the ^{tbu}py ligand and the remaining two positions by two cyano carbon atoms in the trans position.

The main crystallographic data of trans-[Cp(dppe)Fe(NC)Ru(^{tbu}py)₄(CN)Fe(dppe)Cp][PF₆] (n=2, 3, 4) prepared in this example are shown in Table 1 As shown, and the main bond length and bond angle are shown in Table 2.

TABLE 1
Crystallographic Data and Details of Structure Determination for Complexes 1-3

| Complex | trans-[Cp(dppe)Fe(NC)Ru(^{tbu}py)₄(CN)Fe(dppe)Cp][PF₆]₂ |
|---|---|
| CCDC NO. | 1989022 |
| Chemical formula | C₁₀₃H₁₁₆Cl₆F₁₂Fe₂N₆P₆Ru |
| Formula weight | 2277.30 |
| Colour and Habit | Red prism |
| Crystal Size/mm | 0.48 × 0.37 × 0.11 |
| T/K | 123 |
| Crystal system | Monoclinic |
| Space group | P2₁/c |
| a/Å | 13.838(3) |
| b/Å | 30.951(8) |
| c/Å | 25.870(7) |
| α/deg | 90.00 |
| β/deg | 96.100(6) |
| γ/deg | 90.00 |
| V/Å³ | 11017(5) |
| Z | 4 |
| ρ_{calcd}(g/cm³) | 1.373 |
| λ (Mo K_{α}, Å) | 0.71073 |
| μ(Mo K_{α}, mm⁻¹) | 0.695 |
| Completeness | 99.5% |
| F(000) | 4688 |
| h, k, l, range | −16 ≤ h ≤ 15, −36 ≤ k ≤ 36, −30 ≤ l ≤ 28 |
| θ range/deg | 2.15-25.00 |
| Reflections measured | 19323 |
| Rᵢₙₜ | 0.0706 |
| Params/restraints/Data(obs.) | 1306/195/15343 |
| GOF | 1.067 |
| R₁, _{ω}R₂ (I > 2 σ (I)) | 0.0801, 0.1966 |
| R₁, _{ω}R₂ (all data) | 0.1018, 0.2146 |
| Complex | trans-[Cp(dppe)Fe(NC)Ru(^{tbu}py)₄(CN)Fe(dppe)Cp][PF₆]₃ |
| CCDC NO. | 1989024 |
| Chemical formula | C₁₀₆H₁₂₈F₁₈Fe₂N₆O₃P₇Ru |
| Formula weight | 2305.68 |
| Colour and Habit | Red prism |
| Crystal Size/mm | 0.51 × 0.38 × 0.18 |
| T/K | 123 |
| Crystal system | Monoclinic |
| Space group | P2₁/n |
| a/Å | 13.0216(17) |
| b/Å | 32.214(5) |
| c/Å | 27.028(4) |
| α/deg | 90.00 |
| β/deg | 98.184(3) |
| γ/deg | 90.00 |
| V/Å³ | 11222(3) |
| Z | 4 |
| ρ_{calcd}(g/cm³) | 1.361 |
| λ (Mo K_{α}, Å) | 0.71073 |
| μ(Mo K_{α}, mm⁻¹) | 0.568 |
| Completeness | 99.6% |
| F(000) | 4748 |
| h, k, l, range | −15 ≤ h ≤ 14, −38 ≤ k ≤ 37, −32 ≤ l ≤ 32 |
| θ range/deg | 2.08-25.00 |
| Reflections measured | 19688 |
| Rᵢₙₜ | 0.0409 |
| Params/restraints/Data(obs.) | 1423/767/16964 |
| GOF | 1.053 |
| R₁, _{ω}R₂ (I > 2 σ (I)) | 0.0736, 0.2024 |
| R₁, _{ω}R₂ (all data) | 0.0838, 0.2137 |
| Complex | trans-[Cp(dppe)Fe(NC)Ru(^{tbu}py)₄(CN)Fe(dppe)Cp][PF₆]₄ |
| CCDC NO. | 1989023 |
| Chemical formula | C₁₁₅H₁₄₃F₂₄Fe₂N₉O₃P₈Ru |
| Formula weight | 2615.91 |
| Colour and Habit | Brown prism |
| Crystal Size/mm | 0.49 × 0.33 × 0.23 |
| T/K | 123 |
| Crystal system | Orthorhombic |
| Space group | Pbca |
| a/Å | 28.530(6) |
| b/Å | 26.984(5) |
| c/Å | 34.406(7) |
| α/deg | 90.00 |
| β/deg | 90.00 |
| γ/deg | 90.00 |
| V/Å³ | 26487(9) |
| Z | 8 |
| ρ_{calcd}(g/cm³) | 1.312 |
| λ (Mo K_{α}, Å) | 0.71073 |
| μ(Mo K_{α}, mm⁻¹) | 0.508 |
| Completeness | 99.5% |
| F(000) | 10816 |
| h, k, l, range | −33 ≤ h ≤ 33, −29 ≤ k ≤ 32, −40 ≤ l ≤ 40 |
| θ range/deg | 2.05-25.00 |
| Reflections measured | 23181 |
| Rᵢₙₜ | 0.0892 |
| Params/restraints/Data(obs.) | 1558/482/18248 |
| GOF | 1.068 |
| R₁, _{ω}R₂ (I > 2 σ (I)) | 0.0917, 0.2182 |
| R₁, _{ω}R₂ (all data) | 0.1119, 0.2351 |

| Complex | trans-Ru(^{tbu}py)₄(CN)₂ |
|---|---|
| CCDC NO. | 1989021 |
| Chemical formula | C₃₈H₆₂N₆O₅Ru |
| Formula weight | 783.92 |
| Colour and Habit | Orange prism |
| Crystal Size/mm | 0.31 × 0.15 × 0.14 |
| T/K | 123 |
| Crystal system | Trigonal |
| Space group | R-3 |
| a/Å | 25.887(8) |
| b/Å | 25.887(8) |
| c/Å | 15.915(6) |
| α/deg | 90.00 |
| β/deg | 90.00 |
| γ/deg | 120.00 |
| V/Å³ | 9236(6) |
| Z | 9 |
| ρ_{calcd}(g/cm³) | 1.252 |
| λ (Mo K_{α}, Å) | 0.71073 |
| μ(Mo K_{α}, mm⁻¹) | 0.428 |
| Completeness | 97.9% |
| F(000) | 3654 |
| h, k, l, range | −33 ≤ h ≤ 33, −33 ≤ k ≤ 33, −20 ≤ l ≤ 20 |
| θ range/deg | 2.72-27.45 |
| Reflections measured | 4608 |
| Rᵢₙₜ | 0.0663 |
| Params/restraints/Data(obs.) | 354/84/4434 |
| GOF | 1.025 |
| R₁, _{ω}R₂ (I > 2 σ (I)) | 0.0534, 0.1472 |
| R₁, _{ω}R₂ (all data) | 0.0550, 0.1512 |

R₁=Σ∥Fₒ|−|F_{c}∥/Σ|Fₒ|. _{ω}R₂=[Σ[_{ω}(Fₒ²−F_{c}²)²]/Σ[_{ω}(Fₒ²)²]]^{1/2}.

TABLE 2
Selected Bond Lengths (\acute{Å})
and Bond Angles (deg) for Complexes 1-3

| | trans-[Cp(dppe)Fe(NC)Ru(^{tbu}py)₄(CN)Fe(dppe)Cp][PF₆]₂ |
|---|---|
| Ru1—C1 | 2.037(6) |
| Ru1—C2 | 2.046(6) |
| Ru1—N3 | 2.108(5) |
| Ru1—N4 | 2.093(4) |
| Ru1—N5 | 2.101(5) |
| Ru1—N6 | 2.105(5) |
| C1≡N1 | 1.164(7) |
| C2≡N2 | 1.161(7) |
| Fe1—N1 | 1.934(5) |
| Fe2—N2 | 1.924(5) |
| Fe1—P1 | 2.199(2) |
| Fe1—P2 | 2.205(2) |
| Fe2—P3 | 2.197(2) |
| Fe2—P4 | 2.203(2) |
| C1—Ru1—C2 | 178.7(2) |
| N1≡C1—Ru1 | 176.4(5) |
| N2≡C2—Ru1 | 176.9(5) |
| C1≡N1—Fe1 | 173.5(5) |
| C2≡N2—Fe2 | 173.3(4) |
| Fe1 . . . Ru1 | 5.121 |
| Fe2 . . . Ru1 | 5.116 |
| Fe1 . . . Fe2 | 10.228 |
| | trans-[Cp(dppe)Fe(NC)Ru(^{tbu}py)₄(CN)Fe(dppe)Cp][PF₆]₃ |
| Ru1—C1 | 2.051(5) |
| Ru1—C2 | 1.989(4) |
| Ru1—N3 | 2.108(4) |
| Ru1—N4 | 2.092(4) |
| Ru1—N5 | 2.101(4) |
| Ru1—N6 | 2.109(4) |
| C1≡N1 | 1.167(6) |
| C2≡N2 | 1.171(6) |
| Fe1—N1 | 1.916(4) |
| Fe2—N2 | 1.890(4) |
| Fe1—P1 | 2.203(1) |
| Fe1—P2 | 2.207(1) |
| Fe2—P3 | 2.245(1) |
| Fe2—P4 | 2.250(1) |
| C1—Ru1—C2 | 177.3(2) |
| N1≡C1—Ru1 | 178.8(4) |
| N2≡C2—Ru1 | 174.7(4) |
| C1≡N1—Fe1 | 174.8(4) |
| C2≡N2—Fe2 | 176.1(4) |
| Fe1 . . . Ru1 | 5.135 |
| Fe2 . . . Ru1 | 5.049 |
| Fe1 . . . Fe2 | 10.162 |
| | trans-[Cp(dppe)Fe(NC)Ru(^{tbu}py)₄(CN)Fe(dppe)Cp][PF₆]₄ |
| Ru1—C1 | 2.010(6) |
| Ru1—C2 | 2.037(6) |
| Ru1—N3 | 2.108(5) |
| Ru1—N4 | 2.116(5) |
| Ru1—N5 | 2.110(5) |
| Ru1—N6 | 2.104(5) |
| C1≡N1 | 1.157(7) |
| C2≡N2 | 1.171(7) |
| Fe1—N1 | 1.907(5) |
| Fe2—N2 | 1.903(5) |
| Fe1—P1 | 2.283(2) |
| Fe1—P2 | 2.283(2) |
| Fe2—P3 | 2.267(2) |
| Fe2—P4 | 2.275(2) |
| C1—Ru1—C2 | 176.1(2) |
| N1≡C1—Ru1 | 173.8(5) |
| N2≡C2—Ru1 | 176.4(5) |
| C1≡N1—Fe1 | 167.2(5) |
| C2≡N2—Fe2 | 172.4(5) |
| Fe1 . . . Ru1 | 5.047 |
| Fe2 . . . Ru1 | 5.068 |
| Fe1 . . . Fe2 | 10.019 |

| | trans-Ru(^{tbu}py)₄(CN)₂ |
|---|---|
| Ru1—C1 | 2.058(2) |
| Ru1—C2 | |
| Ru1—N3 | 2.107(2) |
| Ru1—N4 | 2.113(2) |
| Ru1—N5 | |
| Ru1—N6 | |
| C1≡N1 | 1.154(3) |
| C2≡N2 | |
| Fe1—N1 | |
| Fe2—N2 | |
| Fe1—P1 | |
| Fe1—P2 | |
| Fe2—P3 | |
| Fe2—P4 | |
| C1—Ru1—C2 | 180.0 |
| N1≡C1—Ru1 | 179.8(2) |
| N2≡C2—Ru1 | |
| C1≡N1—Fe1 | |
| C2≡N2—Fe2 | |
| Fe1 . . . Ru1 | |
| Fe2 . . . Ru1 | |
| Fe1 . . . Fe2 | |

X-ray single crystal diffraction analysis shows that the compound trans-[Cp(dppe)Fe(NC)Ru(^{tbu}py)₄(CN)Fe(dppe)Cp][PF₆]. (n=2 and 3) is a monoclinic system, Centrosymmetric P2₁/cspace group, the compound trans-[Cp(dppe)Fe(NC)Ru(^{tbu}py)₄(CN)Fe(dppe)Cp][PF₆]₄ is an orthorhombic system, centrosymmetric Pbca space group.

In addition, the compound trans-[Cp(dppe)Fe(NC)Ru(^{tbu}py)₄(CN)Fe(dppe)Cp][PF₆]₂ contains three uncoordinated dichloromethane solvent molecules, the compound trans-[Cp(dppe)Fe(NC)Ru(^{tbu}py)₄(CN)Fe(dppe)Cp][PF₆]₃ has two uncoordinated isopropanol and one uncoordinated water solvent molecule, trans-[Cp(dppe)Fe(NC)Ru(^{tbu}py)₄(CN)Fe(dppe)Cp][PF₆]₄ has three uncoordinated isopropanol and three acetonitrile solvent molecules.

It can be seen from Table 2 that the average value of Fe—N bond length in trans-[Cp(dppe)Fe(NC)Ru(^{tbu}py)₄(CN)Fe(dppe)Cp][PF₆)]₂ is 1.929 Å. The average bond length of F—P is 2.201 Å, and the average bond length of Fe—N in trans-[Cp(dppe)Fe(NC)Ru(^{tbu}py)₄(CN)Fe(dppe)Cp][PF₆]₄ is 1.905 Å and Fe—P bond length is 2.227 Å. It can be seen that as the oxidation reaction progresses, the Fe—N bond length decreases, while the Fe—P bond length increases, which shows that trans-[Cp(dppe)Fe(NC)Ru(^{tbu}py)₄(CN)Fe(dppe)Cp][PF₆]₂ are in +2 oxidation state, and trans-[Cp(dppe)Fe(NC)Ru(^{tbu}py)₄(CN)Fe(dppe)Cp][PF₆]₄ are +3 oxidation states, espectively. trans-[Cp(dppe)Fe(NC)Ru(^{tbu}py)₄(CN)Fe(dppe)Cp][PF₆]₃ has an average of Fe1-P bond length of 2.204 Å, an average of Fe2-P bond length of 2.248 Å, an average of Fe1-N1 bond length of 1.196 Å, The average value Fe2-N2 bond length is 1.890 Å. It can be seen that the Fe1-P bond length is shorter than the Fe2-P bond length, and the Fe1-N1 bond length is longer than the Fe2-N2 bond length. This is because Fe2 has fewer anti-bonds to the phosphine ligand, which shows that the two iron centers in trans-[Cp(dppe)Fe(NC)Ru(^{tbu}py)₄(CN)Fe(dppe)Cp][PF₆]₃ have different oxidation states Fe1(+2) and Fe2(+3).

In addition, it can be seen from Table 2 that the compound trans-[Cp(dppe)Fe(NC)Ru(^{tbu}py)₄(CN)Fe(dppe)Cp][PF₆]. (n=2, 3, 4) The shortest Fe . . . Ru^{II} distance is 5.0˜5.1 Å, and the shortest Fe . . . Fe distance connected by the diamagnetic cyano metal bridge NC—Ru^{II}—CN is 10.0˜10.2 Å.

The trans-[Cp(dppe)Fe(NC)Ru(^{tbu}py)₄(CN)Fe(dppe)Cp][PF₆]₂ prepared in this example was dissolved in dichloromethane, and then subjected to a cyclic voltammetry test. The cyclic voltammogram of is shown in FIG. 2. It can be seen from FIG. 2 that two pairs of reversible redox peaks (ΔEₚ=160 mV) appear at +0.29V and +0.45V, and these two pairs of peaks can be assigned as Fe^{II}—Ru^{II}—Fe^{II}/Fe^{II}—Ru^{II}—Fe^{III} and Fe^{II}—Ru^{II}—Fe^{III}/Fe^{III}—Ru^{II}—Fe^{III} redox processes.

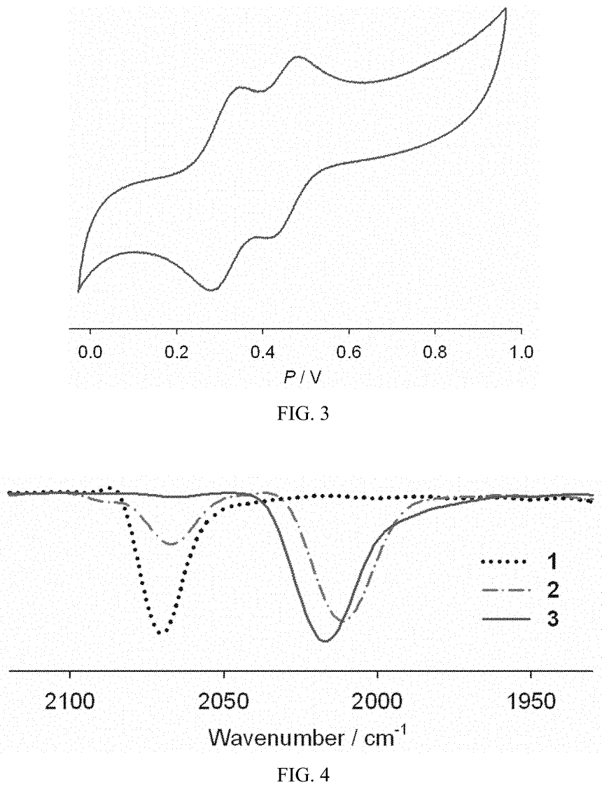

The trans-[Cp(dppe)Fe(NC)Ru(^{tbu}py)₄(CN)Fe(dppe)Cp][PF₆]₂ prepared in this example was dissolved in acetonitrile, and then subjected to a cyclic voltammetry test. The resulting cycle voltammogram is shown in FIG. 3. It can be seen from FIG. 3 that the compound exhibits two redox peaks, which are +0.31V and +0.45V, respectively, corresponding to the redox process of two iron ions, and these two The split between the peaks (140 mV) is greater than the previous Ru(II)-series compounds (110 mV, Ma, X.; Hu, S M; Tan, C H; Zhang, Y F; Zhang, X D; Sheng, T L; Wu, X T, From antiferromagnetic to ferromagnetic interaction in cyanido-bridged Fe(III)-Ru(II)-Fe(III) complexes by change of the central diamagnetic cyanido-metal geometry. Inorg. Chem. 2013, 52 (19), 11343-11350.), which shows that the compound trans-[Cp(dppe)Fe(NC)Ru(^{tbu}py)₄(CN)Fe(dppe)Cp][PF₆)]₂ passes through the cyanide-containing diamagnetic metal bridge NC—Fe^{II} connected by Ru^{II}—CN has stronger metal-metal interaction, or NC—Ru(^{tbu}py)CN bridge has better electron transfer ability.

After testing, the cyclic voltammograms of the compound trans-[Cp(dppe)Fe(NC)Ru(^{tbu}py)₄(CN)Fe(dppe)Cp][PF₆]. (n=2, 3, 4) are all the same The cyclic voltammogram of trans-[Cp(dppe)Fe(NC)Ru(^{tbu}py)₄(CN)Fe(dppe)Cp][PF₆]₂ has two pairs of reversible redox peaks, these two pairs of reversible The redox peak indicates the one-electron oxidation product trans-[Cp(dppe)Fe(NC)Ru(^{tbu}py)₄(CN)Fe(dppe)Cp][PF₆]₃ and the two-electron oxidation product trans-[Cp(dppe)Fe(NC)Ru(^{tbu}py)₄(CN)Fe(dppe)Cp][PF₆]₄ are stable and can be separated.

The trans-[Cp(dppe)Fe(NC)Ru(^{tbu}py)₄(CN)Fe(dppe)Cp][PF₆]. (n=2, 3, 4) prepared in Example 1 was analyzed by infrared spectroscopy. The infrared spectrum is shown in FIG. 4. It can be seen from FIG. 4 that the CN vibration peak of trans-[Cp(dppe)Fe(NC)Ru(^{tbu}py)₄(CN)Fe(dppe)Cp][PF₆]₂ is at 2071 cm⁻¹, while the stretching vibration of CN in its precursor trans-Ru(^{tbu}py)₂(CN)₂ is at 2058 cm⁻¹. This is mainly due to the kinetics when the second metal is connected through the cyano group. The anti-bonding molecular orbital on the factor and the cyano group provides electrons to the Fe′ center through the N atom, thereby enhancing the CN bond force constant and making the cyano group stretching vibration move in the direction of higher wavenumber. With the occurrence of the one-electron oxidation process, the mixed-valence compound trans-[Cp(dppe)Fe(NC)Ru(^{tbu}py)₄(CN)Fe(dppe)Cp][PF₆]₂ is at 2068 cm′ and 2011 cm⁻¹. The stretching vibration peak of the cyano group appears, and the vibration absorption at 2011 cm⁻¹ is attributed to a CN connected to Fe^{III} ions. This is because the electron pulling effect of Fe^{II} makes it easier for electrons to feed back from the metal Ru^{II} to the anti-bonding orbital of the cyano group. As a result, the vibration absorption of the cyano group shifts to a low wave number. The vibration absorption at 2067 cm⁻¹ is attributed to a CN connected to Fe^{II} ions, and its coordination environment is similar to the compound trans-[Cp(dppe)Fe(NC)Ru(^{tbu}py)₄(CN)Fe(dppe)Cp][PF₆)]₂ is very similar. The two-electron oxidation product trans-[Cp(dppe)Fe(NC)Ru(^{tbu}py)₄(CN)Fe(dppe)Cp][PF₆]₄ has a new absorption peak of cyano group at 2018 cm⁻¹, which is relative to the compound trans-[Cp(dppe)Fe(NC)Ru(^{tbu}py)₄(CN)Fe(dppe)Cp][PF₆]₂ has a red shift, which is mainly due to the electron pulling effect of Fe′, which makes it easier for electrons to move from the metal Ru^{II}. The anti-bonding orbital fed back to the cyano group causes the cyano group bond to weaken, so the vibration absorption of the cyano group shifts to a lower wave number.

The trans-[Cp(dppe)Fe(NC)Ru(^{tbu}py)₄(CN)Fe(dppe)Cp][PF₆]. (n=2, 3, 4) prepared in this example was dissolved in acetonitrile, and then analyze the electronic absorption spectrum at room temperature, and the obtained electronic absorption spectrum is shown in FIG. 5. The maximum absorption of compound trans-[Cp(dppe)Fe(NC)Ru(^{tbu}py)₄(CN)Fe(dppe)Cp][PF₆]₂ occurs at 476 nm, which can be classified as d→π* MLCT (metal-ligand charge transition). With the occurrence of the one-electron oxidation process, the one-electron oxidation product trans-[Cp(dppe)Fe(NC)Ru(^{tbu}py)₄(CN)Fe(dppe)Cp][PF₆]₃ shows maximum absorption at 465 nm and 957 nm The peak, 465 nm is attributed to MLCT, and 957 nm is attributed to the superposition of MMCTs (metal-metal charge transition) of middle Ruⁿ→terminal Fe^{III} and remote Fe^{II}→terminal Fe^{III}. The two-electron oxidation product trans-[Cp(dppe)Fe(NC)Ru(^{tbu}py)₄(CN)Fe(dppe)Cp][PF₆]₄ disappears at 957 nm, and appears at 780 nm, which can be assigned It is the center Ru^{II}→the end group Fe^{III} MMCT.

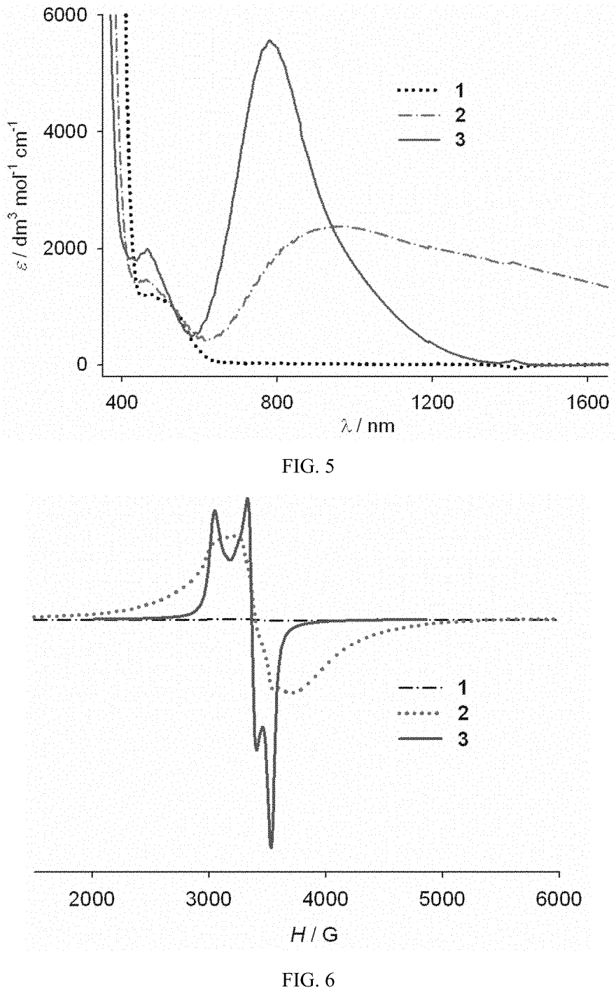

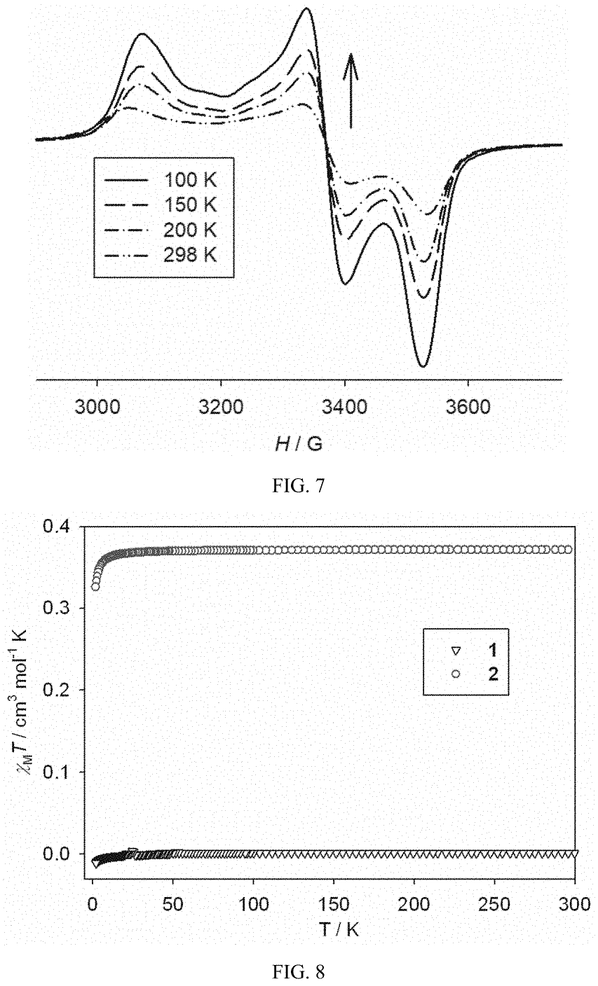

The trans-[Cp(dppe)Fe(NC)Ru(^{tbu}py)₄(CN)Fe(dppe)Cp][PF₆]. (n=2,3,4) prepared in this example was subjected to electron paramagnetic resonance at room temperature, EPR spectrum is shown in FIG. 6. The compound trans-[Cp(dppe)Fe(NC)Ru(^{tbu}py)₄(CN)Fe(dppe)Cp][PF₆]₂ did not detect the EPR signal, It is indeed diamagnetic. The compound trans-[Cp(dppe)Fe(NC)Ru(^{tbu}py)₄(CN)Fe(dppe)Cp][PF₆]₃ detected a relatively broad peak, indicating that the single electron in the compound is not simply localized The free electrons of Fe^{III} ions, but there is an electron delocalization process between Fe^{III}—Ru^{II}—Fe^{II} three metals, which also shows that there is a metal-metal interaction. The compound trans-[Cp(dppe)Fe(NC)Ru(^{tbu}py)₄(CN)Fe(dppe)Cp][PF₆]₄ has three sets of peaks, corresponding to the compound in the three directions of x, y, and z. EPR shows that the compound has paramagnetic anisotropy in three directions, and it also shows that the compound has electron delocalization between FeIII-RuII-FeIII three metals. FIG. 6 shows the g values of the compound trans-[Cp(dppe)Fe(NC)Ru(^{tbu}py)₄(CN)Fe(dppe)Cp][PF₆]₄ in all directions: g₁=2.02, g₂=2.10, g₃=2.25, g=((g₁²+g₂²+g₃²)/3)^{1/2}=2.13, this value is relatively close to the g value of mononuclear compounds and related compounds, which is a typical low-spin near-octahedral d⁵ The characteristic value of the configuration [CpFe^{III}(dppe)]⁺. The trans-[Cp(dppe)Fe(NC)Ru(^{tbu}py)₄(CN)Fe(dppe)Cp][PF₆]₄ prepared in this example was subjected to electron paramagnetic resonance analysis at different temperatures, and the resulting EPR spectrum is shown in FIG. 7, it can be seen from FIG. 7 that as the temperature increases, the EPR signal intensity decreases, and the peak shape becomes less obvious, indicating that the electrons move faster in the compound at high temperatures and the degree of delocalization is higher.

The trans-[Cp(dppe)Fe(NC)Ru(^{tbu}py)₄(CN)Fe(dppe)Cp][PF₆]₂ and trans-[Cp(dppe)Fe(NC)Ru(^{tbu}py)₄(CN)Fe(dppe)Cp][PF6]₃ prepared in this example is subjected to a variable temperature magnetic susceptibility test in an external field of 1000 Oe and a temperature range of 2-300K. The resulting variable temperature magnetic susceptibility curve is shown in FIG. 8, which can be It can be seen that the χ_{M}T value of compound trans-[Cp(dppe)Fe(NC)Ru(^{tbu}py)₄(CN)Fe(dppe)Cp][PF₆]₂ at 2-300K is almost close to 0, indicating that it is indeed anti-magnetic, which is consistent with the results of the EPR experiment. The χ_{M}T of the compound trans-[Cp(dppe)Fe(NC)Ru(^{tbu}py)₄(CN)Fe(dppe)Cp][PF₆]₃ almost maintains a constant 0.341 cm³·K·mol⁻¹ within 30-300K, which is relatively close to the existence of a uncoupled low-spin Fe^{III} (S_{Fe(III)}=½), a diamagnetic Fe^{II} (S_{Fe(II)}=0) and a diamagnetic LS Ru^{II} (S_{Ru(II)}=0) ion. After cooling to 30K, the value of χ_{M}T decreases slowly and reaches the minimum value of 0.300 cm³·K·mol⁻¹ at 2K. It can be seen that this compound is a paramagnetic molecule with the ground state S=½.

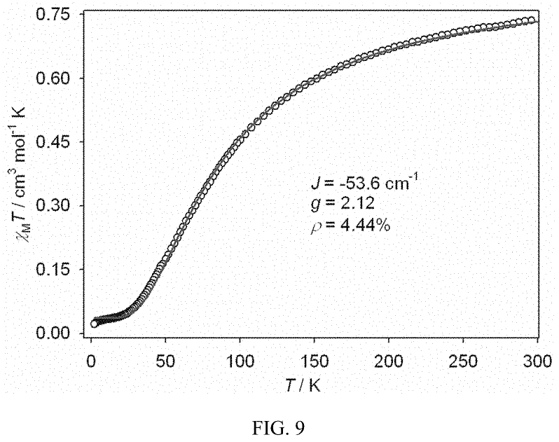

The trans-[Cp(dppe)Fe(NC)Ru(^{tbu}py)₄(CN)Fe(dppe)Cp][PF₆]₄ prepared in this example was subjected to variable temperature magnetization in an external field of 1000 Oe and a temperature range of 2-300K Rate test, the obtained variable temperature magnetic susceptibility curve is shown in FIG. 9. From FIG. 9, it can be seen that the χ_{M}T value of trans-[Cp(dppe)Fe(NC)Ru(^{tbu}py)₄(CN)Fe(dppe)CP][PF₆]₄(PF₆]₄ 300K is 0.74 cm³·K·mol⁻¹, which is related to two low-spin Fe^{III} (S_{Fe(III)}=½) with an uncoupled electron and a diamagnetic LS Ruⁿ (The theoretical value of S_{Ru(II)}=0) ion at g=2.0 is close to 0.75 cm³·K·mol⁻¹. As the temperature decreases, the value of χ_{M}T gradually decreases, then reaches 0.064 cm³·K·mol⁻¹ at 30K, and finally drops rapidly to the minimum value of 0.022 cm³·K·mol⁻¹ at 2K. According to the shape of the temperature-varying magnetic susceptibility curve, it is not difficult to know that this compound is antiferromagnetic interaction, which may be due to the long-range magnetic coupling between the paramagnetic FeIII ions connected through the diamagnetic bridge —NC—Ru^{II}—CN—, and the intermolecular mutual, or it is the spin-orbit coupling of low-spin Fe^{III} ions. According to the magnetic properties of this compound, intermolecular interaction or spin-orbit coupling of low-spin Fe_{III} ions can be excluded. Therefore, the antiferromagnetic interaction mainly comes from the long-range magnetic coupling between the paramagnetic Fe^{III} ions connected by the diamagnetic bridge-NC—Ru^{II}—CN—.

What is claimed is:

1. A cyanide bridged metal organic compound with intramolecular magnetic transition, which is characterized in that its general structural formula is: [(L₂)(L₁)M₁(NC)M₂(L₃)ₘ(CN)M₁(L1)(L2)](PF₆)ₙ; wherein
L2 is cyclopentadiene anion or pentamethylcyclopentadiene anion;
L1 is one selected from the group consisting of: bis(dimethylphosphine)methane, bis(diethylphosphine)methane, bis(dipropylphosphine)methane, bis(diisopropylphosphine)methane, bis(dibutylphosphine)methane, bis(diisopropyl)methane Butylphosphine) methane, bis(di-tert-butylphosphine)methane, bis(diphenylphosphine)methane, bis(dicyclopentylphosphino)methane, bis(dicyclohexylphosphine)methane, bis[(2-Methoxyphenyl) phenylphosphino] methane, 1,2-bis(dimethylphosphine)ethane, 1,2-bis(diethylphosphine)ethane, 1,2-bis(dipropylene) Phosphine) ethane, 1,2-bis(diisopropylphosphine)ethane, 1,2-bis(dibutylphosphine)ethane, 1,2-bis(diisobutylphosphine)ethane, 1,2-bis(di-tert-butylphosphine)ethane, 1,2-bis(dicyclopentylphosphino)ethane, 1,2-bis(dicyclohexylphosphino)ethane, 1,2-Bis(diphenylphosphine)ethane, 1,2-bis[(2-methoxyphenyl)phenylphosphino]ethane, 1,3-bis(dimethylphosphine)propane, 1,3-Bis(diethylphosphine)propane, 1,3-bis(dipropylphosphine)propane, 1,3-bis(diisopropylphosphine)propane, 1,3-bis(dibutylphosphine)propane, 1,3-bis(diisobutylphosphine) propane, 1,3-bis(di-tert-butylphosphine)propane, 1,2-bis(dicyclopentylphosphino)propane, 1,3-bis(di Cyclohexylphosphino) propane, 1,3-bis(diphenylphosphine)propane, 1,3-bis[(2-methoxyphenyl)phenylphosphino]propane, 1,4-bis(dimethyl Phosphine) butane, 1,4-bis(diethylphosphine)butane, 1,4-bis(dipropylphosphine)butane, 1,4-bis(diisopropylphosphine)butane, 1,4-bis(dibutylphosphine)butane, 1,4-bis(diisobutylphosphine)butane, 1,4-bis(di-tert-butylphosphine)butane, 1,2-bis(di Cyclopentylphosphino)butane, 1,4-bis(dicyclohexylphosphine)butane, 1,4-bis(diphenylphosphine)butane and 1,4-bis[(2-methoxybenzene))phenylphosphino]butane;
M₁ and M₂ are respectively one selected from the group consisting of manganese, technetium, rhenium, iron, ruthenium, osmium, cobalt, rhodium and iridium;
m=1, 2 or 4, when m is a different value, L3 is a different ligand, the details are as follows:
when m=4, L3 is one selected from the group consisting of: pyridine, 2-methylpyridine, 3-methylpyridine, 4-methylpyridine, 2-ethylpyridine, 3-ethylpyridine, 4-ethylpyridine, 1,5-lutidine, 1,4-lutidine, 1,3-lutidine, 1,2-lutidine, 2,3-lutidine, 2,4-lutidine, 2,5-lutidine, 2-methoxypyridine, 3-methoxypyridine, 4-methoxypyridine, 2-nitropyridine, 3-nitropyridine, 4-nitropyridine, 2-tert-butylpyridine, 3-tert-butylpyridine, 4-tert-butylpyridine, 2-fluoropyridine, 3-fluoropyridine, 4-fluoropyridine, 2-chloropyridine, 3-chloropyridine, 4-chloropyridine, 2-one selected from the group consisting of bromopyridine, 3-bromopyridine, 4-bromopyridine, 2-iodopyridine, 3-iodopyridine, 4-iodopyridine, 2-cyanopyridine, 3-cyanopyridine and 4-cyanopyridine; trimethyl phosphine, trimethoxy phosphine, dimethyl phosphine chloride, dimethyl phosphine bromide, triethyl phosphine, triethoxy phosphine, diethyl phosphine chloride, diethyl phosphine bromide, dimethyl phenyl phosphine, methyl phenyl phosphine chloride, methyl phenyl phosphine bromide, dimethoxy phenyl phosphine, methoxy phenyl phosphine chloride, methoxy phenyl phosphine bromide, two Ethyl phenyl phosphine, ethyl phenyl phosphine chloride, ethyl phenyl phosphine bromide, diethoxy phenyl phosphine, dipropyl phenyl phosphine, propyl phenyl phosphine chloride, propyl phenyl bromide phosphine, dipropoxyphenyl phosphine, diisopropyl phenyl phosphine, isopropyl phenyl phosphine chloride, isopropyl phenyl phosphine bromide, diisopropoxy phenyl phosphine, dibutoxy phenyl phosphine, dibutyl phenyl phosphine, butyl phenyl phosphine chloride, butyl phenyl phosphine bromide, diisobutoxy phenyl phosphine, diisobutyl phenyl phosphine, isobutyl phenyl chloride phosphine, isobutyl phenyl phosphine bromide, di-tert-butoxy phenyl phosphine, di-tert-butyl phenyl phosphine, tert-butyl phenyl phosphine chloride, tert-butyl phenyl phosphine bromide, dipentyl phenylphosphine, pentylphenylphosphonium chloride, pentylphenylphosphonium bromide, bis(2-cyanoethyl)phenylphosphine, 2-cyanoethylphenylphosphonium chloride, 2-cyanoethyl phenyl phosphine bromide, diphenyl methyl phosphine, diphenyl methoxy phosphine, diphenoxy methoxy phosphine, diphenoxy methyl phosphine, phenoxy methoxy phosphine chloride, benzene oxyl methoxy phosphine bromide, diphenoxy methyl phosphine bromide, diphenoxy methyl phosphine chloride, diphenyl ethyl phosphine, diphenyl ethoxy phosphine, diphenoxy ethoxy phosphine, diphenoxy ethyl phosphine, phenoxy ethoxy phosphine chloride, phenoxy ethoxy phosphine bromide, diphenoxy ethyl phosphine bromide, diphenoxy ethyl phosphine chloride, diphenyl propyl phosphine, diphenyl propoxy phosphine, diphenoxy propoxy phosphine, diphenoxy propyl phosphine, phenoxy propoxy phosphine chloride, phenoxy propoxy bromide phosphine, diphenoxypropyl phosphine bromide, diphenoxypropyl phosphine chloride, diphenyl isopropyl phosphine, diphenyl isopropoxy phosphine, diphenoxy isopropoxy phosphine, diphenoxyisopropylphosphine, phenoxyisopropyloxyphosphonium chloride, phenoxyisopropyloxyphosphonium bromide, diphenoxyisopropylphosphonium bromide, diphenoxyisopropyl chloride phosphine, diphenylbutylphosphine, diphenylbutoxyphosphine, diphenoxybutoxyphosphine, diphenoxybutylphosphine, phenoxybutoxyphosphine chloride, phenoxybutoxy phosphine bromide, diphenoxy butyl phosphine bromide, diphenoxy butyl phosphine chloride, diphenyl isobutyl phosphine, diphenyl isobutoxy phosphine, diphenoxy isobutoxy phosphine, diphenoxy isobutyl phosphine, phenoxy isobutoxy phosphine chloride, phenoxy isobutoxy phosphine bromide, diphenoxy isobutyl phosphine bromide, diphenoxy isobutyl phosphine chloride, diphenyl tert-butyl phosphine, diphenyl tert-butoxy phosphine, diphenoxy tert-butoxy phosphine, diphenoxy tert-butyl phosphine, phenoxy tert-butoxy chlorination phosphine, phenoxy iso-tert-oxy phosphine bromide, diphenoxy tert-butyl phosphine bromide, diphenoxy tert-butyl phosphine chloride, diphenyl pentyl phosphine, diphenyl pentyl oxy phosphine, diphenoxypentyloxyphosphine, diphenoxypentylphosphine, phenoxypentyloxyphosphine chloride, phenoxypentyloxyphosphine bromide, diphenoxypentylphosphine bromide, diphenoxy pentyl phosphine chloride, diphenyl isopentyl phosphine, diphenyl isopentyl phosphine, diphenoxy isopentyl phosphine, diphenoxy isopentyl phosphine, phenoxy isopentyl oxide phosphine chloride, phenoxy isopentyl phosphine bromide, diphenoxy isopentyl phosphine bromide, diphenoxy isopentyl phosphine chloride, diphenyl tert-amyl phosphine, diphenyl tert pentoxy phosphine, diphenoxy tert-pentyl phosphine, diphenoxy tert-pentyl phosphine, phenoxy tert-pentyloxy phosphine chloride, phenoxy iso-tert-oxy phosphine bromide, diphenoxy tert-amyl phosphine bromide, diphenoxy tert-amyl phosphine chloride, di-o-methyl phenyl methyl phosphine, di-o-methyl phenyl methoxy phosphine, di-o-methyl phenoxy methoxy phosphine, di-o-methylphenoxymethyl phosphine, o-methylphenoxy methoxy phosphine chloride, o-methyl phenoxy methoxy phosphonium bromide, di-o-methyl phenoxy methyl phosphonium bromide, di-o-methylphenoxymethyl phosphine chloride, di-o-methyl phenyl ethyl phosphine, di-o-methyl phenyl ethoxy phosphine, di-o-methyl phenoxy ethoxy phosphine, di-o-methyl phenoxyethyl phosphine, o-methylphenoxy ethoxy phosphine chloride, o-methylphenoxy ethoxy phosphonium bromide, di-o-methylphenoxy ethyl phosphonium bromide, di-o-methyl phenoxyethyl phosphine chloride, di-o-methyl phenyl propyl phosphine, di-o-methyl phenyl propoxy phosphine, di-o-methyl phenoxy propoxy phosphine, di-o-methyl phenoxy propyl phosphine, o-methylphenoxy propoxy phosphine chloride, o-methylphenoxy propoxy phosphonium bromide, di-o-methylphenoxy propyl phosphine bromide, di-o-methylphenoxy propyl phosphine chloride, di-o-methyl phenyl isopropyl phosphine, di-o-methyl phenyl isopropoxy phosphine, di-o-methyl phenoxy isopropoxy phosphine, di-o-methyl phenoxy iso propyl phosphine, o-tolu phenoxyisopropyl phosphine chloride, di-o-methyl phenyl butyl phosphine, di-o-methyl phenyl butoxy phosphine, di-o-methyl phenoxy butoxy phosphine, di-o-methyl phenoxy butyl phosphine, o-methylphenoxybutoxy phosphine chloride, o-methylphenoxybutoxy phosphonium bromide, di-o-methylphenoxybutyl phosphine bromide, di-o-methylphenoxy butyl phosphine chloride, di-o-methyl phenyl isobutyl phosphine, di-o-methyl phenyl isobutoxy phosphine, di-o-methyl phenoxy isobutoxy phosphine, di-o-methyl phenoxy iso butyl phosphine, o-methylphenoxy isobutoxy phosphine chloride, o-methylphenoxy isobutoxy phosphonium bromide, di-o-methylphenoxy isobutyl phosphine bromide, di-o-methyl phenoxy isobutyl phosphine chloride, di-o-methyl phenyl tert-butyl phosphine, di-o-methyl phenyl tert-butoxy phosphine, di-o-methyl phenoxy tert-butoxy phosphine, di-o-methyl phenoxy tert-butyl phosphine, o-methylphenoxy tert-butoxy phosphine chloride, o-methylphenoxy iso-tert-oxy phosphine bromide, di-o-methylphenoxy tert-butyl phosphine bromide, di-o-methylphenoxy tert-butyl phosphine chloride, di-o-methyl phenyl pentyl phosphine, di-o-methyl phenyl pentyl phosphine, di-o-methyl phenoxy pentyl oxy phosphine, di-o-methyl phenoxypentyl phosphine, o-methylphenoxypentyl phosphine chloride, o-methylphenoxypentyl phosphine bromide, di-o-methylphenoxypentyl phosphine bromide, di-o-methyl phenoxypentyl phosphine chloride, di-o-methyl phenyl isopentyl phosphine, di-o-methyl phenyl isopentyl phosphine, di-o-methyl phenoxy isopentyl phosphine, di-o-methyl phenoxy isopentyl phosphine, o-methylphenoxy isopentyl phosphine chloride, o-methylphenoxy isopentyl phosphine bromide, di-o-methylphenoxy isopentyl phosphine bromide, di-o-methylphenoxy isopentyl phosphine chloride, di-o-methyl phenyl tert-pentyl phosphine, di-o-methyl phenyl tert-pentyl phosphine, di-o-methyl phenoxy tert-pentyl phosphine, di-o-methylphenoxy tert-amyl phosphine, o-methylphenoxy tert-pentyloxy phosphine chloride, o-methylphenoxy tert-pentyloxy phosphonium bromide, di-o-methylphenoxy tert-amyl phosphine phosphine bromide, di-o-methylphenoxy tert-amyl phosphine chloride, dimethyl phenyl methyl phosphine, dimethyl phenyl methoxy phosphine, dimethyl phenoxy methoxy phosphine, dimethyl phenoxy methyl phosphine, m-methyl phenoxy methoxy phosphine chloride, m-methyl phenoxy methoxy phosphine bromide, dimethyl phenoxy methyl phosphine bromide, dimethylphenoxymethyl phosphine chloride, dimethyl phenyl ethyl phosphine, dimethyl phenyl ethoxy phosphine, dimethyl phenoxy ethoxy phosphine, dimethyl m-methylphenoxyethyl phosphine, m-methylphenoxy ethoxy phosphonium chloride, m-methylphenoxy ethoxy phosphonium bromide, dimethylphenoxyethyl phosphonium bromide, dimethyl phenoxyethyl phosphine bromide phenoxyethyl phosphine chloride, dimethyl phenyl propyl phosphine, dimethyl phenyl propoxy phosphine, dimethyl phenoxy propoxy phosphine, dimethyl phenoxy propyl phosphine, m-methylphenoxy propoxy phosphine chloride, m-methylphenoxy propoxy phosphonium bromide, dimethyl phenoxy propyl phosphine bromide, dimethyl phenoxy propyl phosphine chloride, dimethyl phenyl isopropyl phosphine, dimethyl phenyl isopropoxy phosphine, dimethyl phenoxy isopropoxy phosphine, dimethyl phenoxy iso propyl phosphine, m-methylphenoxy isopropoxy phosphine chloride, m-methylphenoxy isopropoxy phosphine bromide, dimethyl phenoxy isopropyl phosphine bromide, dimethyl phenoxy isopropyl phosphine bromide phenoxyisopropyl phosphine chloride, dimethyl phenyl butyl phosphine, dimethyl phenyl butoxy phosphine, dimethyl phenoxy butoxy phosphine, dimethyl phenoxy butyl phosphine, m-methylphenoxybutoxy phosphine chloride, m-methylphenoxybutoxy phosphonium bromide, dimethylphenoxybutyl phosphine bromide, dimethylphenoxy butyl phosphine chloride, dimethyl phenyl isobutyl phosphine, dimethyl phenyl isobutoxy phosphine, dimethyl phenoxy isobutoxy phosphine, dimethyl phenoxy iso butyl phosphine, m-methylphenoxy isobutoxy phosphine chloride, m-methylphenoxy isobutoxy phosphonium bromide, dimethyl phenoxy isobutyl phosphonium bromide, dimethyl phenoxy isobutyl phosphine bromide phenoxy isobutyl phosphine chloride, dimethyl phenyl tert-butyl phosphine, dimethyl phenyl tert-butoxy phosphine, dimethyl phenoxy tert-butoxy phosphine, dimethyl phenyl phenoxy tert-butyl phosphine, m-methylphenoxy tert-butoxy phosphine chloride, m-methylphenoxy iso-tert-oxy phosphine bromide, dimethylphenoxy tert-butyl phosphine bromide, dim-methylphenoxy tert-butyl phosphine chloride, dimethyl phenylpentyl phosphine, dimethyl phenyl pentyl phosphine, dimethyl phenoxy pentyl phosphine, dimethyl phenoxypentyl phosphine, m-methylphenoxypentyl phosphine chloride, m-methylphenoxypentyl phosphine bromide, dimethylphenoxypentyl phosphine bromide, dimethyl phenoxypentyl phosphine bromide phenoxypentyl phosphine chloride, dimethyl phenyl isopentyl phosphine, dimethyl phenyl isopentyl phosphine, dimethyl phenoxy isopentyl phosphine, dimethyl phenoxy isopentyl phosphine, m-methylphenoxy isopentyl phosphine chloride, m-methylphenoxy isopentyl phosphine bromide, dimethyl phenoxy isopentyl phosphine bromide, dim-methylphenoxy isopentyl phosphine chloride, dimethyl phenyl tert-pentyl phosphine, dimethyl phenyl tert-pentyl phosphine, dimethyl phenoxy tert-pentyl phosphine, dim-methylphenoxy tert-amyl phosphine, m-methylphenoxy tert-amyloxy phosphine chloride, m-methylphenoxy tert-amyloxy phosphonium bromide, dimethylphenoxy tert-amyl phosphine phosphine bromide, di-m-methylphenoxy tert-amyl phosphine chloride, di-p-tolyl methyl phosphine, di-p-tolyl methoxy phosphine, di-p-tolyl oxy methoxy phosphine, two-p-tolyl tolyloxymethyl phosphine, p-tolyloxy methoxy phosphine chloride, p-tolyloxy methoxy phosphine bromide, di-p-tolyloxy methyl phosphine bromide, di-p-tolyloxy methyl phosphine chloride, di-p-tolyl ethyl phosphine, di-p-tolyl ethoxy phosphine, di-p-tolyloxy ethoxy phosphine, di-p-tolyl oxy ethyl phosphine, p-tolyl oxygen ethoxy phosphine chloride, p-tolyloxy ethoxy phosphonium bromide, di-p-tolyloxy ethyl phosphonium bromide, di-p-tolyloxy ethyl phosphine chloride, di-p-tolyl propyl phosphine, di-p-tolyl propoxy phosphine, di-p-tolyloxy propoxy phosphine, di-p-tolyloxy propyl phosphine, p-tolyloxy propoxy phosphine chloride, p-tolyloxy propoxy phosphine bromide, di-p-tolyloxy propyl phosphine bromide, di-p-tolyloxy propyl phosphine chloride, di-p-tolyl isopropyl phosphine, di-p-tolyl isopropoxy phosphine, di-p-tolyloxy isopropoxy phosphine, di-p-tolyloxy isopropyl phosphine, p-tolyloxy isopropoxy phosphine chloride, p-tolyloxy isopropoxy bromide phosphine, di-p-tolyloxy isopropyl phosphine bromide, di-p-tolyloxy isopropyl phosphine chloride, di-p-tolyl butyl phosphine, di-p-tolyl butoxy phosphine, di-p-toluene oxybutoxy phosphine, di-p-tolyloxy butyl phosphine, p-tolyloxy butoxy phosphine chloride, p-tolyloxy butoxy phosphine bromide, di-p-tolyloxy butyl phosphine bromide, two-p-tolyloxybutyl phosphine chloride, two-p-tolyl isobutyl phosphine, two-p-tolyl isobutoxy phosphine, two p-tolyloxy isobutyl phosphine, p-tolyloxy isobutoxy phosphine chloride, p-tolyloxy isobutoxy phosphonium bromide, two p-tolyloxy isobutyl phosphine bromide, two p-tolyloxy isobutyl phosphine chloride, di-p-tolyl tert-butyl phosphine, di-p-tolyl tert-butoxy phosphine, di-p-tolyloxy tert-butoxy phosphine, di-p-tolyl oxygen tert-butyl phosphine, p-tolyloxy tert-butoxy phosphine chloride, p-tolyloxy iso-tert-oxy phosphonium bromide, di-p-tolyloxy tert-butyl phosphine bromide, di-p-tolyloxy tert-butyl phosphine chloride, di-p-tolyl pentyl phosphine, di-p-tolyl pentyl phosphine, di-p-tolyl oxypentyl phosphine, di-p-tolyl pentyl phosphine, p-toluene oxypentyloxy phosphine chloride, p-tolyloxy pentyl phosphine bromide, di-p-tolyloxy pentyl phosphonium bromide, di-p-tolyloxy pentyl phosphine chloride, di-p-tolyl 2-methyl isopentyl phosphine, di-p-tolyl isopentoxy phosphine, di-p-tolyloxy isopentyl phosphine, di-p-tolyloxy isopentyl phosphine, p-tolyloxy isopentoxy chloride phosphine bromide, p-tolyloxy isopentyl phosphine bromide, di-p-tolyloxy isopentyl phosphine bromide, di-p-tolyloxy isopentyl phosphine chloride, di-p-tolyl tert-pentyl phosphine, di-p-tolyl tert-pentyl phosphine, di-p-tolyl oxy tert-pentyl phosphine, di-p-tolyl tert-pentyl phosphine, p-tolyloxy tert-pentyl phosphine chloride, p-tolyloxy tert-pentyl phosphine bromide, two-p-tolyloxy tert-pentyl phosphine bromide, two-p-tolyl oxy tert-amyl phosphine chloride, diphenyl (trimethylsilyl) phosphine, phenyl (trimethylsilyl) phosphine chloride, phenyl (trimethylsilyl) phosphine bromide, allyl diphenyl phosphine, allyl phenyl phosphine chloride, allyl phenyl phosphine bromide, diphenyl cyclohexyl phosphine, diphenoxy cyclohexyl phosphine, phenoxy cyclohexyl phosphine chloride, phenoxy cyclohexyl phosphine bromide, phenylcyclohexyl phosphine bromide, phenylcyclohexyl phosphine chloride, bis(3,5-dimethylphenyl)methylphosphine, (3,5-dimethylphenyl)methyl phosphine chloride, (3,5-dimethylphenyl)methylphosphonium bromide, bis(3,5-dimethylphenyl)methoxyphosphine, bis(3,5-dimethylphenyl)) methoxy phosphine bromide, bis(3,5-dimethylphenyl) methoxyphosphine chloride, bis(3,5-dimethylphenyl)ethyl phosphine, (3,5-dimethylphenyl) phenyl) ethyl phosphine chloride, (3,5-dimethylphenyl) ethyl phosphine bromide chloride, bis(3,5-dimethylphenyl) ethoxyphosphine, (3,5-dimethylphenyl)ethoxyphosphonium bromide, (3,5-dimethylphenyl)ethoxyphosphonium chloride, bis(3,5-dimethylphenyl)propylphosphine, (3,5-dimethylphenyl)propylphosphonium chloride, (3,5-dimethylphenyl)propylphosphonium bromide chloride, bis(3,5-dimethylphenyl)propoxyphosphine, (3,5-dimethylphenyl)propoxyphosphonium bromide, (3,5-dimethylphenyl)propoxyphosphonium chloride, bis(3,5-dimethylphenyl)iso propylphosphine, (3,5-dimethylphenyl) isopropyl phosphine chloride, (3,5-dimethylphenyl) isopropyl phosphine bromide chloride, bis(3,5-dimethylphenyl) phenyl)isopropoxyphosphine, (3,5-dimethylphenyl)isopropoxyphosphine bromide, (3,5-dimethylphenyl)isopropoxyphosphine chloride, bis(3,5-dimethylphenyl)butylphosphine, (3,5-dimethylphenyl)butylphosphine chloride, (3,5-dimethylphenyl);
when m=2, L3 is one selected from the group consisting of: 2,2′-dipyridine, 3-methyl-2,2′-dipyridine, 4-methyl-2,2′-dipyridine, 5-methyl-2,2′-Bipyridine, 6-methyl-2,2′-bipyridine, 4-chloro-2,2′-bipyridine, 5-chloro-2,2′-bipyridine, 6-chloro-2,2′-bipyridine, 4-bromo-2,2′-bipyridine, 5-bromo-2,2′-bipyridine, 6-bromo-2,2′-bipyridine, 4-methoxy-2,2′-bipyridine, 5-methoxy-2,2′-bipyridine, 6-methoxy-2,2′-bipyridine, 4-cyano-2,2′-bipyridine, 5-cyano-2,2′-bipyridine, 6-cyano-2,2′-bipyridine, 4-tert-butyl-2,2′-bipyridine, 5-tert-butyl-2,2′-bipyridine, 6-tert-butyl-2,2′-bipyridine, 4,4′-dimethyl-2,2′-bipyridine, 5,5′-dimethyl-2,2′-bipyridine, 6,6′-dimethyl-2,2′-bipyridine, 4,4′-dicyano-2,2′-bipyridine, 5,5′-dicyano-2,2′-bipyridine, 6,6′-dicyano-2,2′-bipyridine, 4,4′-dimethoxy-2,2′-bipyridine, 5,5′-dimethoxy-2,2′-bipyridine, 6,6′-dimethoxy-2,2′-bipyridine, 4,4′-di-tert-butyl-2,2′-bipyridine, 5,5′-dipyridine tert-butyl-2,2′-bipyridine, 6,6′-di-tert-butyl-2,2′-bipyridine, 4,4′-dichloro-2,2′-bipyridine, 5,5′-dichloro-2,2′-bipyridine, 6,6′-dichloro-2,2′-bipyridine, 4,4′-dibromo-2,2′-bipyridine, 5,5′-dipyridine bromo-2,2′-bipyridine, 6,6′-dibromo-2,2′-bipyridine, 2,2′-biquinoline, 4,4′-diphenyl-2,2′-bipyridine pyridine, 1,10-phenanthroline, 2-chloro-1,10-phenanthroline, 3-chloro-1,10-phenanthroline, 4-chloro-1,10-phenanthroline, 5-chloro-1,10-phenanthroline, 2-bromo-1,10-phenanthroline, 3-bromo-1,10-phenanthroline, 4-bromo-1,10-phenanthroline phenanthroline, 5-bromo-1,10-phenanthroline, 2-methyl-1,10-phenanthroline, 3-methyl-1,10-phenanthroline, 4-methyl-1,10-phenanthroline, 5-methyl-1,10-phenanthroline, 2-methoxy-1,10-phenanthroline, 3-methoxy-1,10-phenanthroline, 4-methoxy-1,10-phenanthroline, 5-methoxy-1,10-phenanthroline, 2-cyano-1,10-phenanthroline, 3-cyano-1,10-phenanthroline, 4-cyano-1,10-phenanthroline, 5-cyano-1,10-phenanthroline, 2-nitro-1,10-phenanthroline, 3-nitro-1,10-phenanthroline, 4-nitro-1,10-phenanthroline, 5-nitro base-1,10-phenanthroline, 2-tert-butyl-1,10-phenanthroline, 3-tert-butyl-1,10-phenanthroline, 4-tert-butyl-1,10-phenanthroline, 5-tert-butyl-1,10-phenanthroline, 2,9-dimethyl-1,10-phenanthroline, 3,8-dimethyl-1,10-phenanthroline, 4,7-dimethyl-1,10-phenanthroline, 5,6-dimethyl-1,10-phenanthroline, 3,4,7,8-tetramethyl-1,10-phenanthroline, 2,9-dichloro-1,10-phenanthroline, 3,8-dichloro-1,10-phenanthroline, 4,7-dichloro-1,10-phenanthroline, 5,6-dichloro-1,10-phenanthroline, 3,4,7,8-tetrachloro-1,10-phenanthroline, 2,9-dibromo-1,10-phenanthroline, 3,8-dibromo-1,10-phenanthroline, 4,7-dibromo-1,10-phenanthroline, 5,6-dibromo-1,10-phenanthroline, 3,4,7,8-tetrabromo-1,10-phenanthroline, 2,9-dimethoxy-1,10-phenanthroline, 3,8-dimethoxy-1,10-phenanthroline, 4,7-dimethoxy-1,10-phenanthroline, 5,6-dimethoxy-1,10-phenanthroline, 3,4,7,8-tetramethoxy-1,10-phenanthroline, 2,9-dicyano-1,10-phenanthroline, 3,8-dicyano-1,10-phenanthroline, 4,7-dicyano-1,10-phenanthroline, 5,6-dicyano-1,10-phenanthroline, 3,4,7,8-tetracyano 1,10-phenanthroline, 2,9-dinitro-1,10-phenanthroline, 3,8-dinitro-1,10-phenanthroline, 4,7-dinitro-1,10-phenanthroline, 5,6-dinitro-1,10-phenanthroline, 3,4,7,8-tetranitro-1,10-phenanthroline, bis(dimethylphosphine)methane, bis(diethylphosphine)methane, bis(dipropylphosphine)methane, bis(diisopropylphosphine)methane, bis(dibutylphosphine)methane, bis(diisopropyl)methane butylphosphine) methane, bis(di-tert-butylphosphine)methane, bis(diphenylphosphine)methane, bis(dicyclopentylphosphino)methane, bis(dicyclohexylphosphino)methane, bis(diphenyl) phosphine) methane, bis[(2-methoxyphenyl)phenylphosphino]methane, 1,2-bis(dimethylphosphine)ethane, 1,2-bis(diethylphosphine)ethane, 1,2-bis(dipropylphosphine)ethane, 1,2-bis(diisopropylphosphine)ethane, 1,2-bis(dibutylphosphine)ethane, 1,2-bis(Diisobutylphosphine) ethane, 1,2-bis(di-tert-butylphosphine)ethane, 1,2-bis(dicyclopentylphosphino)ethane, 1,2-bis(dicyclohexyl) phosphine) ethane, 1,2-bis(diphenylphosphine)ethane, 1,2-bis[(2-methoxyphenyl)phenylphosphino]ethane, 1,3-bis(diphenylphosphine)ethane methylphosphine) propane, 1,3-bis(diethylphosphine) propane, 1,3-bis(dipropylphosphine) propane, 1,3-bis(diisopropylphosphine) propane, 1,3-bis(dibutylphosphine)propane, 1,3-bis(diisobutylphosphine)propane, 1,3-bis(di-tert-butylphosphine)propane, 1,2-bis(dicyclopentylphosphino)propane, 1,3-bis(dicyclohexylphosphino)propane, 1,3-bis(diphenylphosphine)propane, 1,3-bis[(2-methoxyphenyl)phenylphosphino]propane, 1,4-bis(dimethylphosphine)butane, 1,4-bis(diethylphosphine)butane, 1,4-bis(di propylphosphine) butane, 1,4-bis(diisopropylphosphine)butane, 1,4-bis(dibutylphosphine)butane, 1,4-bis(diisobutylphosphine)butane, 1,4-bis(di-tert-butylphosphino)butane, 1,2-bis(dicyclopentylphosphino)butane, 1,4-bis(dicyclohexylphosphino)butane, 1,4-one of bis(diphenylphosphine)butane and 1,4-bis[(2-methoxyphenyl)phenylphosphino]butane;
when m=1, L3 is one selected from the group consisting of: 2,2′:6′,2″:6″,2′″-tetrabipyridine, 2-methyl-2,2′:6′,2″:6″,2″-tetrapyridine, 3-methyl-2,2′:6′,2″:6″,2′-tetrapyridine, 4-methyl-2,2′:6′,2″:6″,2′″-tetrabipyridine, 5-methyl-2,2′:6′,2″:6″,2′″-tetra bipyridine, 6-methyl-2,2′:6′,2″:6″,2′″-tetrabipyridine, 7-methyl-2,2′:6′,2″:6″,2′″-tetrapyridine, 8-methyl-2,2′:6′,2″:6″,2′″-tetrapyridine, 2-methoxy-2,2′:6′,2″:6″,2′″-tetrabipyridine, 3-methoxy-2,2′:6′,2″:6″,2′″-tetrapyridine, 4-methoxy-2,2′:6′,2″:6″,2′″-tetrapyridine, 5-methoxy-2,2′:6′,2″:6″,2′″-tetrapyridine, 6-methoxy-2,2′:6′,2″:6″,2′″-Tetrapyridine, 7-methoxy-2,2′:6′,2″:6″,2′″-tetrabipyridine, 8-methoxy-2,2′:6′,2″:6″,2′″-tetrapyridine, 2-nitro-2,2′:6′,2″:6″,2′″-tetrapyridine, 3-nitro-2,2′:6′,2″:6″,2″-tetrabipyridine, 4-nitro-2,2′:6′,2″:6″,2′″-tetrabipyridine, 5-nitro-2,2′:6′,2″:6″,2″-tetrabipyridine, 6-nitro-2,2′:6′,2″:6″,2′″-tetrapyridine, 7-nitro-2,2′:6′,2″:6″,2″-tetrapyridine, 8-nitro-2,2′: 6′,2″:6″,2″-tetrabipyridine, 2-cyano-2,2′:6′,2″:6″,2′″-tetrabipyridine, 3-cyano-2,2′:6′,2″:6″,2′″-tetrabipyridine, 4-cyano-2,2′:6′,2″:6″,2′″-tetrapyridine, 5-cyano-2,2′:6′,2″:6″,2′″-tetrapyridine, 6-cyano-2,2′:6′,2″:6″,2′″-tetrabipyridine, 7-cyano-2,2′:6′,2″:6″,2′″-tetrabipyridine, 8-cyano-2,2′:6′,2″:6″,2′″-tetrabipyridine, 2-chloro-2,2′:6′,2″:6″,2′″-tetrabipyridine, 3-chloro-2,2′:6′,2″:6″,2′″-tetrabipyridine, 4-chloro-2,2′:6′,2″:6″,2′″-tetrapyridine, 5-chloro-2,2′:6′,2″:6″,2′″-tetrabipyridine, 6-chloro-2,2′:6′,2″:6″,2′″-tetrapyridine, 7-chloro-2,2′:6′,2″:6″,2′″-tetrapyridine, 8-chloro-2,2′:6′,2″:6″,2′″-tetrapyridine, 2-bromo-2,2′:6′,2″:6″,2′″-tetrapyridine, 3-bromo-2,2′:6′,2″:6″,2′″-tetrabipyridine, 4-bromo-2,2′:6′,2″:6″,2′″-tetra bipyridine, 5-bromo-2,2′:6′,2″:6″,2′″-tetrabipyridine, 6-bromo-2,2′:6′,2″:6″,2′″-tetrabipyridine, 7-bromo-2,2′:6′,2″:6″,2′″-tetrabipyridine and 8-bromo-2,2′:6′,2″:6″,2″-tetrapyridine;
n=2, 3, or 4.

2. A method for preparing a cyanide-bridged metal organic compound with intramolecular magnetic transition according to claim 1, comprising the following steps:
(1) under argon atmosphere, adding M₁(L₃)ₘ(CN)₂ to alcohol, nitrile or ketone solvent, then M₂(L₁)(L₂)X is added, where X is Cl, Br or I; after reacting the resulting mixture at 50-120° C. for 5-24 hours, NH₄PF₆ is then added to prepare a diamagnetic cyanide bridged metal organic compound [(L₂)(L₁)M₁(NC-μ)M₂(L₃)ₘ(μ-CN)M₁(L₁)(L₂)](PF₆)₂;
(2) dissolving [(L₂)(L₁)M₁(NC)M₂(L₃)ₘ(CN)M₁(L₁)(L₂)](PF₆)₂ in the halogenated hydrocarbon solvent, then oxidant A is added, reacting at 20-80° C. for 1-12 hours, the paramagnetic cyanide bridged metal organic compound [(L₂)(L₁)M₁(NC)M₂(L₃)ₘ(CN)M₁(L₁)(L₂)](PF₆)₃ is obtained;
(3) dissolving [(L₂)(L₁)M₁(NC)M₂(L₃)ₘ(CN)M₁(L₁)(L₂)](PF₆)₃ in a halogenated hydrocarbon solvent, oxidant B is added, reacting at 20-80° C. for 1-12 hours to prepare antiferromagnetic or ferromagnetic cyanide bridged metal organic compound [(L₂)(L₁)M₁ (NC)M₂(L₃)ₘ(CN)M₁(L₁)(L₂)](PF₆)₄.

3. The preparation method of cyano-bridged metal organic compound with intramolecular magnetic transition according to claim 2, it is characterized in that: the alcohol solvent is one selected from the group consisting of: methanol, ethanol, propanol, isopropanol, butanol, tertiary one selected from the group consisting of butanol, 1-pentanol, 2-pentanol, 3-pentanol, 1-hexanol, 2-hexanol and 3-hexanol; nitrile solvent is one selected from the group consisting of: acetonitrile, propionitrile, butyronitrile and valeronitrile; ketone solvent is one selected from the group consisting of: acetone, methyl ethyl ketone, n-pentanone and hexanone.

4. The preparation method of cyanide bridged metal organic compound with intramolecular magnetic transition according to claim 2, characterized in that: the halogenated hydrocarbon is monochloromethane, dichloromethane, trichloromethane, tetrachloride one selected from the group consisting of carbon, ethyl chloride, 1,2-dichloroethane, 1-chloropropane, 2-chloropropane, and 1,2-dichloropropane.

5. The preparation method of cyanide bridged metal organic compound with intramolecular magnetic transition according to claim 2, characterized in that: the oxidant A and the oxidant B is one selected from the group consisting of oxyacetic acid, sodium dichromate, chromic acid, peroxy ammonium sulfate, sodium hypochlorite, sodium percarbonate, sodium perborate, potassium perborate, Na₂O₂, K₂O₂, MgO₂, CaO₂, BaO₂, H₂O₂, F₂, Cl₂, O₂, O₃, Br₂, 1₂, 5, Si, KMnO₄, KClO₃, H₂SO₄, HNO₃, MnO₂, FeCl₃, Fe(NO₃)₃, Fe(ClO₄)₃, Fe(BF₄)₃, Fe(PF₆)₃, CpFe(BF₄), CpFe(PF₆), RuCb, Ru(NO₃)₃, Ru(ClO₄)₃, Ru(BF₄)₃, Ru(PF₆)₃, CpRu(BF₄), CpRu(PF₆), Cu(ClO₄)₂, CuCl₂, Cu(PF₆)₂, Cu(BF₄)₂, Cu(NO₃)₂, CpCu(BF₄), CpCu(PF₆), AgNO₃, AgPF₆ and AgBF₄.

6. The preparation method of cyanide bridged metal organic compound with intramolecular magnetic transition according to claim 2, characterized in that: the molar ratio of M₁(L₃)ₘ(CN)₂, M₂(L₁)(L₂)X and NH₄PF₆ is 1:1.01-4.99:1.02-4.99, the ratio of [(L₂)(L₁)M₁(NC)M₂(L₃)₄CN)M₁(L₁)(L₂)](PF₆)₂ and oxidant A is 1:0.49-1.99, the molar ratio of [(L₂)(L₁)M₁(NC)M₂(L₃)₄CN)M₁(L₁)(L₂)](PF₆)₃ to oxidant B is 1:0.99-3.99.

7. The use of the cyano-bridged metal organic compound with intramolecular magnetic transition of claim 1 as a magnetic material.
